(19) United States
(12) Patent Application Publication
(10) Pub. No.: US 2023/0162124 A1
(43) Pub. Date: May 25, 2023

(54) PROJECT DIAGNOSIS DATABASE SYSTEM

(71) Applicant: MANAGEMENT SOLUTIONS CO., LTD., Tokyo (JP)

(72) Inventors: Shinya TAKAHASHI, Tokyo (JP); Toshinari GOTO, Tokyo (JP); Ryo HASEGAWA, Tokyo (JP); Yi ZHANG, Tokyo (JP); Akira KANEKO, Tokyo (JP)

(73) Assignee: MANAGEMENT SOLUTIONS CO., LTD., Tokyo (JP)

(21) Appl. No.: 18/094,194

(22) Filed: Jan. 6, 2023

Related U.S. Application Data
(63) Continuation of application No. PCT/JP2021/026110, filed on Jul. 12, 2021.

(30) Foreign Application Priority Data
Jul. 16, 2020 (JP) 2020-121838

(51) Int. Cl. G06Q 10/0639

(52) U.S. Cl. CPC G06Q 10/06395

(57) ABSTRACT

A project diagnosis DB system that diagnoses whether a project is properly operated while the project is in progress and provides a database storing the results of diagnosis. The project diagnosis DB system includes a project diagnosis template storage configured to storage a plurality of project diagnosis templates each provided with a plurality of diagnosis items composed of diagnosis sentences in predetermined sentences for checking the proper operability of the project, a project diagnosis template selector configured to allow a user to select a project diagnosis template for checking the proper operability of the project being operated, and a project diagnosis sheet register configured to register the selected project diagnosis template as a project diagnosis sheet in association with information to be associated.

### CROSS-REFERENCE TO RELATED APPLICATION

This application is a continuation application of International Application PCT/JP2021/026110 filed on Jul. 12, 2021 and designated the U.S., which claims the benefits of priorities of Japanese Patent Application No. 2020-121838 filed on Jul. 16, 2020, the entire contents of which are incorporated herein by reference.

### FIELD

The present invention relates to a system capable of providing a mechanism for achieving a single or a plurality of relatively large-scale projects in a relatively labor-saving manner, a mechanism for inputting and managing information for efficiently utilizing resources, and a system capable of enhancing the project achievement ability of members involved in the projects. In particular, its main feature is that the system is evaluated and diagnosed according to the progress of the project.

### BACKGROUND

The above-described system has conventionally existed as a system for judging whether a so-called project is progressing well or not. An example thereof is Japanese Laid-Open Patent Publication No. 03-198102 (hereinafter referred to as Patent Document 1).

### SUMMARY

According to an aspect of the present disclosure, there is provided a project diagnosis DB system that diagnoses whether a project is properly operated while the project is in progress and provides a database storing the results of diagnosis. The project diagnosis DB system includes a project diagnosis template storage configured to storage a plurality of project diagnosis templates each provided with a plurality of diagnosis items composed of diagnosis sentences in predetermined sentences for checking the proper operability of the project, a project diagnosis template selector configured to allow a user to select a project diagnosis template for checking the proper operability of the project being operated, and a project diagnosis sheet register configured to register the selected project diagnosis template as a project diagnosis sheet in association with information to be associated.

The project diagnosis DB system may further include a project diagnosis sheet comparer configured to calculate an average value for each industry, each type of industry, or each type of project based on accumulated diagnosis result information of a plurality of projects, and set target values classified into a high level target value, a standard target value, and a low level target value.

The project diagnosis DB system may further include a functional unit configured to, after evaluating the proper operability of the project, automatically evaluate the proper operability of the project based on data input through a function of schedule management, problem management, risk management, change management, or quality management, and output an improvement status.

The project diagnosis template may include at least a diagnosis sentence that prompts the user to answer whether a project plan is utilized for unifying intention or consciousness after the start of the project.

The project diagnosis template may include at least a diagnosis sentence that prompts the user to answer whether incident management is utilized as a management indicator after a test phase.

The project diagnosis template may include at least a diagnosis sentence that prompts the user to answer whether a master schedule is applied to progress management of the whole project.

The project diagnosis template may include at least a diagnosis sentence that prompts the user to answer a level of involvement or a degree of influence of a concurrent member who is engaged in a regular work and the project.

The project diagnosis template may include at least a diagnosis sentence that prompts the user to answer whether information is shared with parties concerned, whether agreement is formed with the parties concerned, or whether intention is unified with the parties concerned.

The project diagnosis template may include at least a diagnosis sentence that prompts the user to answer whether a criterion for a problem to be immediately shared with a higher-level organization is clarified, whether quantitative management is performed, or whether a department and a plan corresponding to a problem are clarified.

The project diagnosis template may include at least a diagnosis sentence that prompts the user to answer whether parties concerned agree on a necessity of determining a baseline or a judgment criterion or taking a measure for change.

The project diagnosis template may include at least a diagnosis sentence that prompts the user to answer whether a phase can be started after clarifying what is deliverables.

The project diagnosis template may include at least a diagnosis sentence that prompts the user to answer whether misunderstanding between the parties concerned is reduced and a quality of an upstream process of the project is improved, by centrally managing requirements using a list.

The project diagnosis template may include at least a diagnosis sentence that prompts the user to answer whether a preparation rule of a work schedule or a progress rate setting is clarified.

The project diagnosis template may include at least a diagnosis sentence that prompts the user to the user answer whether consistency between a master schedule and a work schedule or consistency between the deliverables and the work schedule is confirmed.

The project diagnosis template may include at least a diagnosis sentence that prompts the user to answer whether a person who reviews deliverables is clarified, a review task is registered in a work schedule, or a progress status of a review is visualized, in quality assurance.

The project diagnosis template may include at least a diagnosis sentence that prompts the user to answer whether a participation schedule of undecided members or validity of skills and man-hours is confirmed.

The project diagnosis template may include at least a diagnosis sentence that prompts the user to answer whether a meeting is set in consideration of reporting to a higher level, a content of the meeting is reviewed according to a situation, or a planned meeting is appropriately managed.

The project diagnosis template may include at least a diagnosis sentence that prompts the user to whether an appropriate number of risks is extracted or a project-specific measure is considered, in risk management.

As described above, it is possible to provide a project diagnosis DB system capable of appropriately inputting information for evaluating a status of a project even by a person who is not accustomed to the project. In addition, the status evaluation of the appropriate project is made based on the input information.

### BRIEF DESCRIPTION OF THE DRAWINGS

FIGS. 1A and 1B are diagrams illustrating a functional configuration of a project diagnosis DB system according to a first embodiment;

FIGS. 2A to 2C are diagrams illustrating a hardware configuration of the project diagnosis DB system according to the first embodiment;

FIG. 3 is a diagram illustrating a flow of processing when the project diagnosis DB system according to the first embodiment is used;

FIGS. 4A and 4B are diagrams illustrating a functional configuration of the project diagnosis DB system according to a second embodiment;

FIGS. 5A to 5C are diagrams illustrating a hardware configuration of the project diagnosis DB system according to the second embodiment;

FIG. 6 is a diagram illustrating a flow of processing when the project diagnosis DB system according to the second embodiment is used;

FIGS. 7A and 7B are diagrams illustrating a functional configuration of the project diagnosis DB system according to a third embodiment;

FIGS. 8A to 8C are diagrams illustrating a hardware configuration of the project diagnosis DB system according to the third embodiment;

FIG. 9 is a diagram illustrating a flow of processing when the project diagnosis DB system according to the third embodiment is used;

FIGS. 10A and 10B are diagrams illustrating a functional configuration of a project diagnosis database system according to a fourth embodiment;

FIGS. 11A to 11C are diagrams illustrating a hardware configuration of the project diagnosis database system according to the fourth embodiment;

FIG. 12 is a diagram illustrating a flow of processing when the project diagnosis DB system according to the fourth embodiment is used.

FIGS. 13A and 13B are diagrams illustrating a functional configuration of the project diagnosis DB system according to a fifth embodiment;

FIGS. 14A to 14C are diagrams illustrating a hardware configuration of the project diagnosis database system according to the fifth embodiment;

FIG. 15 is a diagram illustrating a flow of processing when the project diagnosis DB system according to the fifth embodiment is used;

FIGS. 16A and 16B are diagrams illustrating a functional configuration of the project diagnosis DB system according to a sixth embodiment;

FIGS. 17A to 17C are diagrams illustrating a hardware configuration of the project diagnosis DB system according to the sixth embodiment;

FIG. 18 is a diagram illustrating a flow of processing when the project diagnosis DB system according to the sixth embodiment is used;

FIGS. 19A and 19B are diagrams illustrating a functional configuration of the project diagnosis DB system according to a seventh embodiment;

FIGS. 20A to 20C are diagrams illustrating a hardware configuration of the project diagnosis DB system according to the seventh embodiment;

FIG. 21 is a diagram illustrating a flow of processing when the project diagnosis DB system according to the seventh embodiment is used.

FIGS. 22A and 22B are diagrams illustrating a functional configuration of the project diagnosis DB system according to an eighth embodiment;

FIGS. 23A to 23C are diagrams illustrating a hardware configuration of the project diagnosis DB system according to the eighth embodiment;

FIG. 24 is a diagram illustrating a flow of processing when the project diagnosis DB system according to the eighth embodiment is used;

FIGS. 25A and 25B are diagrams illustrating a functional configuration of the project diagnosis DB system according to a ninth embodiment;

FIGS. 26A to 26C are diagrams illustrating a hardware configuration of the project diagnosis DB system according to the ninth embodiment;

FIG. 27 is a diagram illustrating a flow of processing when the project diagnosis DB system according to the ninth embodiment is used;

FIGS. 28A and 28B are diagrams illustrating a functional configuration of the project diagnosis DB system according to a tenth embodiment;

FIGS. 29A to 29C are diagrams illustrating a hardware configuration of the project diagnosis DB system according to the tenth embodiment;

FIG. 30 is a diagram illustrating a flow of processing when the project diagnosis DB system according to the tenth embodiment is used;

FIGS. 31A and 31B are diagrams illustrating a functional configuration of the project diagnosis DB system according to an eleventh embodiment;

FIGS. 32A to 32C are diagrams illustrating a hardware configuration of a project diagnosis DB system according to the eleventh embodiment;

FIG. 33 is a diagram illustrating a flow of processing when the project diagnosis DB system according to the eleventh embodiment is used;

FIG. 34 is a diagram illustrating an example of a diagnosis sentence of a project diagnosis template;

FIG. 35 is a diagram illustrating an example of a diagnosis sentence of a project diagnosis template;

FIG. 36 is a diagram illustrating an example of a diagnosis sentence of a project diagnosis template; and

FIG. 37 is a diagram illustrating an example of a diagnosis sentence of a project diagnosis template.

### DESCRIPTION OF EMBODIMENTS

Patent Document 1 discloses a technical idea or problem of diagnosing a project success probability in a project progress stage.

However, according to Patent Document 1, a user who wishes to perform a project diagnosis freely considers the contents of input each time and wishes to perform the diagnosis, and it is difficult to perform appropriate input unless the user is originally accustomed to a project. As a result, the optimal project diagnosis could not be implemented.

This disclosure provides a project diagnosis database (DB) system that allows even a person unfamiliar with the project to enter information appropriately.

Embodiments of the present disclosure will be described below with reference to the accompanying drawings. Each claim is not limited to the following embodiments, and various changes and modifications may be made to the embodiments without departing from the scope of the invention disclosed in the claims.

<Hardware Constituting the Present System>

The system is basically an embodiment using a computer, but is realized by software, by hardware, or by cooperation between software and hardware. The hardware for realizing all or part of the constituent elements of the disclosure comprises a CPU, a memory, a bus, an input/output device, various peripheral devices, a user interface and the like which are basic components of a computer. The various peripheral devices include storage devices, interfaces such as the Internet, devices such as the Internet, displays, keyboards, mice, speakers, cameras, videos, televisions, various sensors for monitoring production conditions in laboratories or factories (e.g. flow rate sensors, temperature sensors, weight sensors, liquid amount sensors, infrared sensors, shipment number counters, packaging number counters, foreign matter inspection devices, defect counters, radiation inspection devices, surface condition inspection devices, circuit inspection devices, human sensors, workers' work situation monitoring devices (images, ID, PC work volume, etc.)), CD devices, DVD devices, Blu-ray devices, USB memories, USB memory interfaces, removable hard disks, general hard disks, projector devices, SSDs, telephones, faxes, copiers, printing devices, movie editing devices, and various sensor devices. Further, the present system does not necessarily have to be constituted by one housing, but may be constituted by connecting a plurality of housings by communication. Further, the communication may be a local area network (LAN), a WANWifi, Bluetooth (registered trademark), infrared communication, or ultrasonic communication, and a part of the communication may be installed across national borders. Further, each of the plurality of housings may be operated by a different entity or may be operated by a single entity. The operating entity of the system of the present disclosure may be a single entity or a plurality of entities. In addition to the present system, the embodiment can also be constituted as a system including a terminal used by a third party and a terminal used by another third party. Further, these terminals may be installed across national borders. Further, in addition to the present system and the terminal, a device used for registering related information of a third person and related persons, a device used for a database for recording the contents of the registration, and the like may be prepared. These information may be provided in the present system, or the present system may be configured to be provided outside the present system so that these information can be used.

<Fulfillment of Applicability of Natural Law of Present System>

The system functions in cooperation between a computer, a communication facility, and software. In addition to simply making it possible to use ICTs (Information and Communication Technology) to process the processes conventionally performed by project participants in interviews, the system also includes processes unique to ICTs, such as the exchange of many complex project-related information, determining the effects of procedures, certifications, and payments, and supporting the accumulation, retention, and exchange of effective information that meets all necessary requirements that cannot be created without expertise. Thus, the system can be regarded as a business model patent. In addition, various identification information, risk information, problem information, and task information are held or processed in each unit. From this point of view as well, if resources such as computers are determined based on the matters described in the claims and the description and the common general knowledge related to those matters, the system of the present application is considered to utilize a law of nature.

<Significance of Use of Natural Laws Required by the Patent Law>

The utilization of the natural laws required by the Patent Law is required to ensure that an invention is industrially useful from the viewpoint that the invention must have industrial applicability and contribute to the development of industry based on the nature. In other words, it is required that the invention is industrially useful, that is, the effect of the invention declared at the time of filing can be reproduced by carrying out the invention with a certain degree of certainty. From this point of view, the applicability of the laws of nature is interpreted as meaning that the function of each of the matters used to define the invention (the constituent elements of the invention), which is the constitution of the invention for exerting the effect of the invention, can be exerted by utilizing the laws of nature. Furthermore, the effect of an invention should only be the possibility of providing a prescribed usefulness to the user who uses the invention, and should not be seen in terms of how the user feels or thinks about the usefulness. Therefore, even if the effect obtained by the user by this system is a psychological effect, the effect itself is an event outside the scope of the utilization of the required laws of nature.

### First Embodiment

Provided is a project diagnosis database (DB) system for diagnosing whether a project is operated properly during the progress of the project and providing a database storing the results thereof, wherein a plurality of project diagnosis templates each provided with a plurality of diagnosis items composed of diagnosis sentences in predetermined sentences for checking the proper operability of the project are stored, a user is made to select a project diagnosis template for checking the proper operability of the project being operated, the diagnosis timing which is the timing for diagnosing the project is acquired in order to associate with a project diagnosis sheet described later, the project identification information which is the identification information of the project to be diagnosed is acquired in order to associate with the project diagnosis sheet described later, the project diagnosis sheet including the selected diagnosis template is registered in association with information to be associated, a diagnosis input which is an input for judging whether the project is being operated properly is received for each diagnosis item of the project diagnosis sheet, an evaluation rule for evaluating the received diagnosis input is stored, and the proper operability of the project is evaluated based on the stored evaluation rule and the input diagnosis input.

The functional configuration, the hardware configuration and the flow of processing of the project diagnosis DB system according to the present embodiment will be described in order.

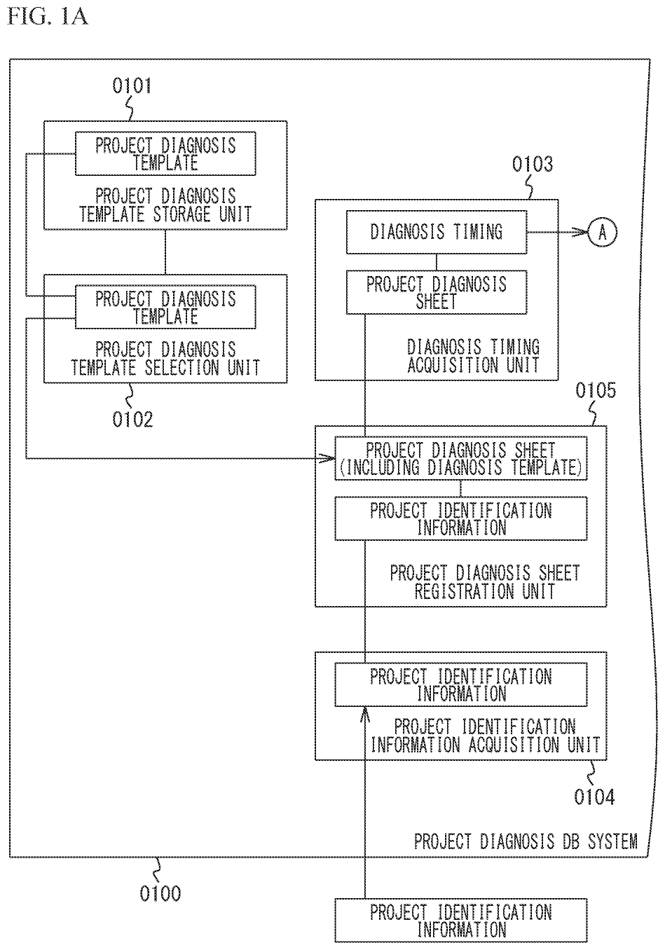

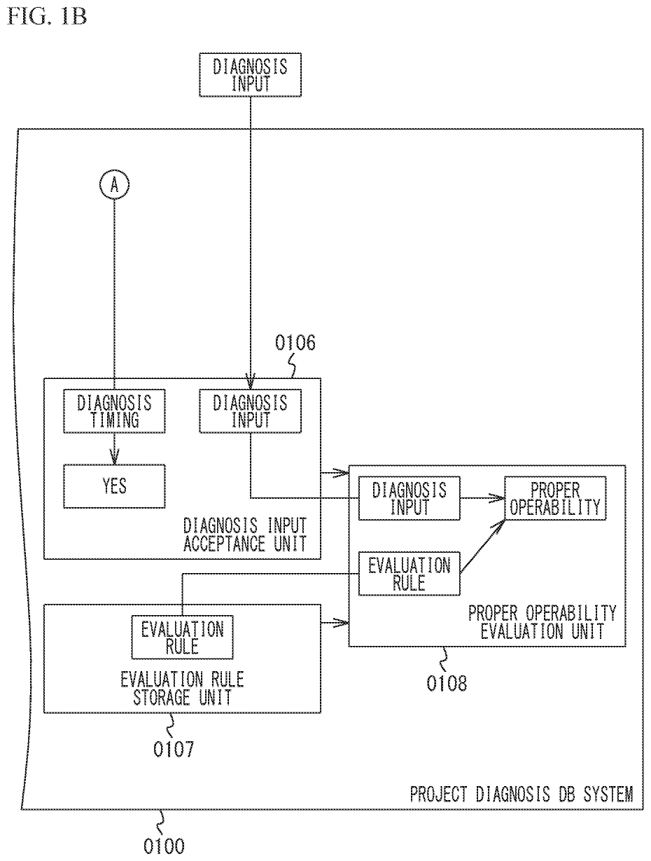

FIGS. 1A and 1B are diagrams illustrating the functional configuration of the project diagnosis DB system according to the first embodiment. A project diagnosis DB system (0100) of the present embodiment includes a project diagnosis template storage unit (0101), a project diagnosis template selection unit (0102), a diagnosis timing acquisition unit (0103), a project identification information acquisition unit (0104), a project diagnosis sheet registration unit (0105), a diagnosis input acceptance unit (0106), an evaluation rule storage unit (0107), and a proper operability evaluation unit (0108). Further, the project diagnosis DB system includes a timing registration unit and a diagnosis timing determination unit. The same applies to the following embodiments.

The present system diagnoses whether a project is operated properly during the progress of the project and provides a database storing the results thereof, which is the same in all of the following embodiments.

The “project diagnosis template storage unit” has a function of storing a plurality of project diagnosis templates each provided with a plurality of diagnosis items composed of diagnosis sentences in predetermined sentences for checking the proper operability of the project. It is desirable that the “project diagnosis template” has a hierarchical structure in which the plurality of diagnosis items constitute a project management type which is a middle management layer, a plurality of project management types constitute a knowledge area which is a higher layer, and a plurality of knowledge areas constitute the whole. Further, it is preferable that the project management type of the project diagnosis template stored in the project diagnosis template storage unit includes at least one of a management type of planning diagnosis for quantitatively diagnosing the project from the viewpoint of planning, a management type of problem management for quantitatively diagnosing the project from the viewpoint of problem management, a management type of change management for quantitatively diagnosing the project from the viewpoint of change management of the project process, a management type of incident management for quantitatively diagnosing the project from the viewpoint of incident management, a management type of standard document management for quantitatively diagnosing the project from the viewpoint of standard document, and a management type of scope management for quantitatively diagnosing the project from the viewpoint of scope management indicating future prospects.

The “project diagnosis template” is used to diagnose the project, and is used by the parties responsible for the project to fill in the information required in the template. Typically, the template is configured to be selected from pull-down menus, check boxes, drop-down forms, etc., or to be filled in or selected by determining the level. As a result of examining what conditions are necessary for the success of the project, the template proved academically appropriate to have the following structure.

First, the situation of the project is examined in the following major item. The major item is defined as each knowledge of integration, scope, schedule, cost, quality, resources, communication, risk, procurement and stakeholder.

The “integration” is a template area for checking whether an appropriate start state is indicated as the start of the project and an appropriate end state is indicated as the end of the project, and whether they are realized. The “integration” also checks the project based on how the project execution side should respond to change requests that occur during the project execution. The “integration” is a knowledge area that has a cross-sectional impact on other management areas and check areas described later, and can be said to be the most important management area. Accordingly, other items of the overall project diagnosis template are configured to be affected by this integration item. The “integration” can be further subdivided into “project plan”, “problem management”, “change management”, “incident management”, and “configuration management”, so that the integration function can be executed more precisely. “Project diagnosis template” must have a diagnosis function for the above subdivided items.

“Project plan” requires that there is a project plan, information on “project background, outline, process definition, master schedule, project execution system, and project management rule” is defined, and check items related to these are prepared.

For “problem management”, it is necessary to configure check items in the project diagnosis template on the assumption that “problem management has been implemented and been regularly added and updated, and the person in charge and the response schedule have been clarified”.

“Change management” is carried out on the premise that “standards and rules to be subject to change management have been clarified, all change requests after the baseline was established have been centrally managed, and whether to respond can be decided based on judgment criteria such as cost effectiveness”. The check items in the project diagnosis template are check items constructed on this premise.

“Incident Management” is configured on the premise that “Incident Management has been implemented”. The project diagnosis template is configured on the premise that Incident Management has been implemented or is going to be implemented. The term “incident” here refers to an “obstacle event” to the project execution.

“Configuration management” is performed on the premise that configuration management has been performed for documents and programs (documents and programs for project implementation, or not required if there is none). Therefore, the check items included in the project diagnosis template concerning configuration management become check items concerning this configuration management.

As described above, the project diagnosis template is composed of a plurality of diagnosis items for diagnosing one theme, and when the project diagnosis template described later is selected, the person responsible for the project determines whether to select each of the diagnosis items for each theme. The project diagnosis template is configured so as to be selected according to the project actually scheduled, and one project diagnosis sheet is configured corresponding to every project. The type of project includes a project to produce hardware such as machines, equipment, plants and products (in this case, the project diagnosis template always includes diagnosis items including processes related to tests and experiments), a project to produce software such as software and systems (in this case, the project diagnosis template always includes diagnosis items carried out at the time of requirement definition), a project to produce services (in this case, the project diagnosis template always includes diagnosis items carried out at the time of small-scale demonstrations), an influence-type project to affect society (in this case, the project diagnosis template always includes diagnosis items carried out at the time of a questionnaire survey), and a structural reform project to prevent disasters and epidemics or reform the social structure to recover from the adverse effects of disasters (in this case, the project diagnosis template always includes diagnosis items carried out at the time of a public opinion survey). An appropriate template can be selected according to the attribute of each project.

The final diagnosis items of the project diagnosis template has a conceptually hierarchical structure such as major items (for example, “integration”), intermediate items (for example, “project plan”), and minor items (for example, “project plan document”).

The “project diagnosis template” may be selectable in units of intermediate items, in units of major items, or even a collection of major items as a whole. Preferably, however, the project diagnosis template is configured to be selected as the collection of major items because the diagnosis items are interrelated and also intermediate items and major items are interrelated.

The stored “project diagnosis template” is comprehensively prepared so that it can correspond to various projects. A plurality of templates are displayed on the screen, and the contents of each template can be known from the name and outline of the displayed template. Thus, users can select a template from the screen and select the most suitable template for the project they are about to implement.

The embodiments are characterized in that a template can be selected from a collection of templates. In addition, the selected template adopts a style of multi-faceted diagnosis of the essential management items in the project indicated by the intermediate items located in an upper level between the diagnosis items in advance, so that the absence of diagnosis does not occur. Although some of the essential management items may differ depending on the type of project, the essential management items corresponding to almost all types of projects constitute the project diagnosis template and can be selected.

The “project diagnosis template selection unit” has a function of allowing the user to select a project diagnosis template for allowing the user to check the proper operability of the project being operated. The selection of the project diagnosis template is displayed on the display in the table of contents type, and the interface is constituted so that the contents of the template can be recognized gradually with the hierarchical structure. The lowest layer of the hierarchical structure is the diagnosis item itself of the project diagnosis template. The selection is configured to be selected by check boxes, pull-down menus, drop-down forms, etc. In addition, it is preferable that the user can browse and refer to the configuration of the past project diagnosis sheet at the time of selection. This is because the qualification of diagnosis can be judged by knowing the diagnosis contents of the past successful projects.

The “project diagnosis sheet registration unit” has a function of registering the selected diagnosis template as a project diagnosis sheet in association with information to be associated. By registering, the contents of the project diagnosis sheet are determined.

The “diagnosis input acceptance unit” has a function of accepting a diagnosis input which is an input for judging whether the project is properly operated for each diagnosis item of the project diagnosis sheet. In addition, the diagnosis input acceptance unit may include a predetermined format input acceptance unit configured to perform at least one of selection of an option for the diagnosis item of the diagnosis template and input of a numerical value level determined within a predetermined range.

The “evaluation rule storage unit” has a function of storing an evaluation rule for evaluating the accepted diagnosis input.

The “proper operability evaluation unit” has a function of evaluating the proper operability of the project based on the stored evaluation rule and the input diagnosis input.

It is desirable that the proper operability evaluation unit has a knowledge area evaluation unit for evaluating the project in units of knowledge areas at each diagnosis timing.

Further, in the embodiments, in addition to the above-described features, it is desirable that the proper operability evaluation unit has a common evaluation unit for evaluating the evaluation for each knowledge area with a common evaluation axis even when templates included in different project diagnosis sheets are selected and diagnosis results are input.

Although the basic configuration of the present system has been described above, the present system may further include a “project diagnosis sheet generation unit” which has a function of generating a project diagnosis sheet including the selected diagnosis template based on the selected diagnosis template. When the project diagnosis sheet is generated, the project diagnosis template used for the project diagnosis is basically determined. At this point, the selection of the project diagnosis template is completed. However, it may be possible to return to the selection of the project diagnosis template after the generation.

The system may further include a “timing registration unit”, which may have a function of registering a diagnosis timing, which is a timing for diagnosing a project using the registered project diagnosis sheet, in association with the project identification information. This function is not required, but it is flexible to make decisions by inputting the timing. The project diagnosis is basically performed at the timing of “startup”, “requirement definition”, “basic design”, “implementation”, “integration test”, “system test”, “operation test”, “migration” and “termination” of the project.

The “startup” here is just the launch of the project, and an initial point at which the project starts. At this point, the basic plan of the project and the structure of the project are settled.

The “requirement definition” is a process of determining what is needed for a project. It is a phase in which matters necessary to achieve the objective of the project are finalized.

The “basic design” is a phase that establishes the procedure to satisfy the matters required for the achievement of the project determined in the requirements definition. This basic design will specify the “implementation” of the next phase.

The “implementation” is a process of realizing the required matters specified in the basic design and a process of acquiring concrete deliverables.

The “integration test” is a process of integrating the deliverables of the implementation performed by multiple groups and cooperating them. Originally, the deliverables obtained by the “implementation” produce one effect by combining multiple things, and the cooperation between the deliverables of the implementation is tested as a step before combining the whole.

The “system test” is the culmination of the integration test in which all necessary project components are combined and tested for their effectiveness in meeting the project objectives. While the integration test is meant to combine some of the implementation deliverables, the system test is meant to test the overall effect.

The “operation test” is to operate the system in an environment close to the actual operation, and it is to see whether the appropriate effect obtained by the system test is demonstrated in the environment close to the actual operation.

The “migration” is a process of migrating the system to the environment where the system operator actually operates the system and porting it there when the appropriate effect is obtained in the operation test. Since the environment of system test is different from the environment of actual operation, it is a phase to obtain the appropriate effect of the project demonstrated in the operation test.

The “termination” is a phase in which project activities are terminated after confirming that appropriate effects have been achieved after the migration, establishing the conditions necessary for proper operation of the effects of the designed project deliverables over their intended lifetime, and confirming that the necessary conditions have been met.

The system may optionally include a “diagnosis timing judgment unit”. The “diagnosis timing judgment unit” has a function of judging whether the registered diagnosis timing has arrived or not. The diagnosis timing to be registered in advance is, for example, a scheduled start date of each phase.

<Hardware Configuration>

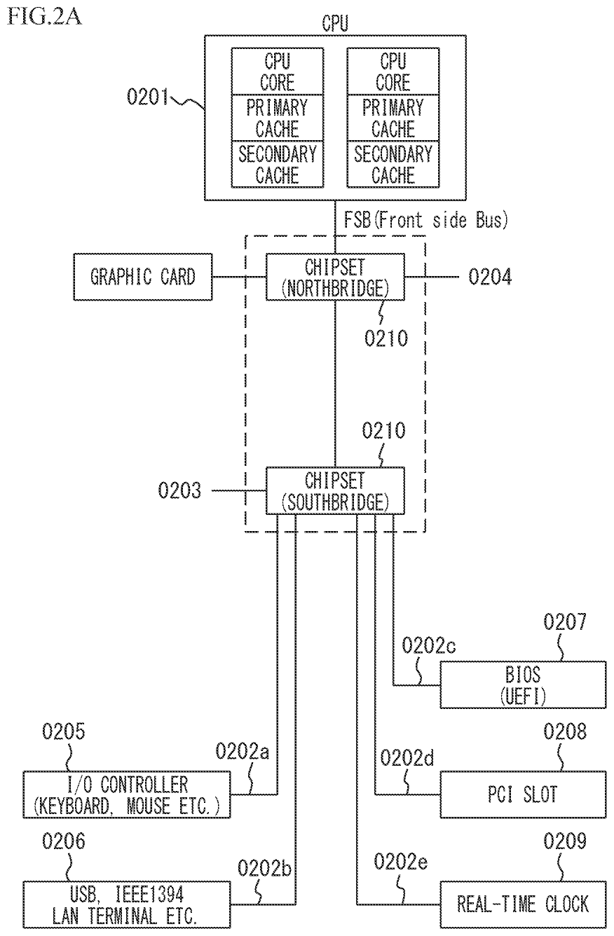

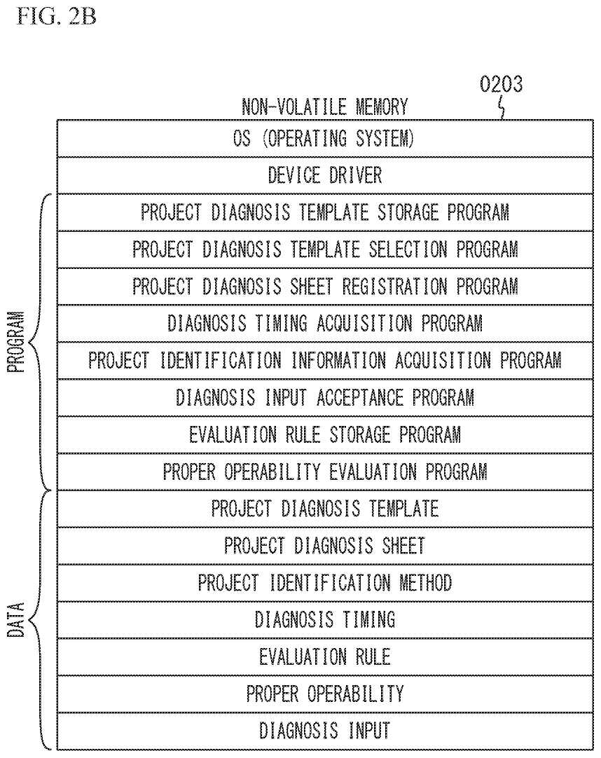

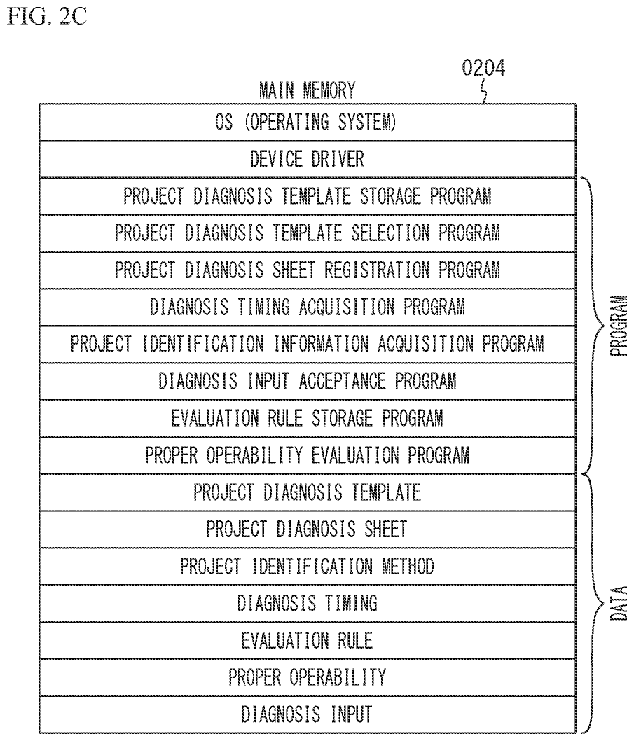

FIGS. 2A to 2C are diagrams illustrating an example of the hardware configuration in the present embodiment. The hardware configuration of the project diagnosis DB system according to the present embodiment will be described with reference to drawings.

As illustrated in FIGS. 2A to 2C, a computer includes a chip set, a CPU, a non-volatile memory, a main memory, various buses, a BIOS, various interfaces, a real-time clock, and the like, which are configured on a motherboard. They work in conjunction with operating systems, device drivers and programs. Various programs and various data constituting the embodiment are configured to execute various processes by efficiently utilizing these hardware resources.

<Chipset>

The “chipset” is a set of large-scale integrated circuits (LSI) mounted on a motherboard of the computer and integrated with a communications function, i.e., a bridge function between an external bus of CPUs and a standard bus for connecting memories and peripheral devices. A two chip set configuration may be employed or a one chip set configuration may be employed. A north bridge is provided near the CPU and main memory, and a south bridge is provided near an interface with the external I/O which is relatively low speed.

(North Bridge)

The north bridge includes a CPU interface, a memory controller, and a graphics interface. Most of the functions of the conventional north bridge may be carried out by the CPU. The north bridge is connected to the memory slot of the main memory through a memory bus, and to a graphics card slot of a graphics card through a high-speed graphics bus (AGP, PCI Express).

(South Bridge)

The south bridge is connected to a PCI interface (PCI slot) via a PCI bus and performs I/O functions and sound functions with an ATA (SATA) interface, a USB interface, an Ethernet interface, etc. The incorporation of circuits that support PS/2 ports, floppy disk drives, serial ports, parallel ports, and ISA buses for which high-speed operation is not necessary or possible is a drag on the speedup of the chip set itself, so the circuits may be separated from the south bridge chip and placed in charge of another LSI called a Super I/O chip. Buses are used to connect the CPU (MPU) to peripheral devices and various control units. The buses are connected to the chip set. A memory bus used for connection with the main memory may adopt a channel structure instead of the memory bus in order to achieve high speed. A serial bus or a parallel bus can be adopted as the bus. In the parallel bus, while the serial bus transfers data one bit at a time, the original data itself or a plurality of bits extracted from the original data are bundled into one block and transmitted simultaneously through a plurality of communication paths. A dedicated line for the clock signal is provided in parallel with a data line to synchronize data demodulation on the receiving side. It is also used as a bus to connect a CPU (chip set) and external devices, such as GPIB, IDE/(parallel) ATA, SCSI, and PCI. Since there is a limit to the speedup, the data line may be the serial bus in the improved PCI Express of PCI or the improved serial ATA of parallel ATA.

<CPU>

The CPU reads a sequence of instructions called a program in the main memory in order, interprets and executes them, and outputs information composed of signals to the main memory. The CPU functions as a center of operation in the computer. It should be noted that the CPU is composed of a CPU core part as a center of calculation and peripheral parts thereof, and includes a register, a cache memory, an internal bus for connecting the cache memory and the CPU core, a DMA controller, a timer, an interface with a connection bus to the north bridge, and the like inside the CPU. A plurality of CPU cores may be provided in one CPU (chip). In addition to the CPU, processing may be performed by a graphic interface (GPU) or an FPU.

<Non-volatile Memory> (HDD)

The basic structure of a hard disk drive comprises a magnetic disk, a magnetic head, and an arm on which the magnetic head is mounted. The external interface can be SATA (ATA in the past). Communication between hard disk drives is supported by using a high-functional controller, such as SCSI. For example, when a file is copied to another hard disk drive, the controller can read the sector, transfer and write it to another hard disk drive. At this time, the memory of the host CPU is not accessed. Therefore, it is not necessary to increase the load of the CPU.

<Main Memory>

The CPU directly accesses and executes various programs on main memory. The main memory is a volatile memory using DRAM. The program on the main memory is developed from the non-volatile memory onto the main memory in response to an instruction to start the program. Thereafter, the CPU executes the program in accordance with various execution instructions and execution procedures in the program.

<Operating System (OS)>

The operating system is used to manage resources on the computer for applications, manage various device drivers, and manage the computer itself which is hardware. In a small computer, firmware may be used as the operating system.

<BIOS>

The BIOS is the hardware which causes the CPU to execute the procedure for starting up the hardware of the computer and operating the operating system, and is most typically the hardware which the CPU first reads when the computer is instructed to start. The address of the operating system stored in the disk (non-volatile memory) is described therein, and the operating system is sequentially expanded in the main memory by the BIOS expanded in the CPU to be in an operating state. The BIOS also has a check function for checking the presence or absence of various devices connected to the bus. The results of the checks are stored in main memory and made available to the operating system as appropriate. The BIOS may be configured to check an external device or the like.

The above is also applicable to other embodiments.

As illustrated in FIGS. 2A to 2C, the embodiment can be basically constituted by general-purpose computer programs and various devices. The operation of a computer basically takes a form in which programs recorded in the nonvolatile memory is loaded into the main memory and processing is executed by the main memory, the CPU, and various devices. Communication with the devices is performed through an interface connected to a bus line. The interface may be a display interface, a keyboard, a communication buffer, or the like.

As illustrated in FIGS. 2A to 2C, the nonvolatile memory stores: a “project diagnosis template storage program” for storing a plurality of project diagnosis templates composed of diagnosis sentences in predetermined sentences for checking the proper operability of the project; a “project diagnosis template selection program” for allowing the user to select a project diagnosis template for checking the proper operability of the project being operated; a “diagnosis timing acquisition program” for acquiring a diagnosis timing which is a timing for diagnosing a project in order to associate it with the project diagnosis sheet to be described later; a “project identification information acquisition program” for acquiring project identification information, which is identification information of the project to be diagnosed, in order to associate the project identification information with the project diagnosis sheet to be described later; a “project diagnosis sheet registration program” for registering a selected diagnosis template as the project diagnosis sheet in association with information to be associated; a “diagnosis input acceptance program” for accepting a diagnosis input which is an input for judging whether the project is properly operated for each diagnosis item of the project diagnosis sheet; an “evaluation rule storing program” for storing evaluation rules to evaluate the accepted diagnosis input; and a “proper operability evaluation program” for evaluating the proper operability of the project based on the stored evaluation rule and the inputted diagnosis input. These programs are read into the main memory based on the execution instruction of a series of programs, and these programs are executed based on an operation start instruction. In this computer, the non-volatile memory, the main memory, the CPU, and the interface (for example, a display, a keyboard, communication, etc.) are connected to the bus lines so that they can communicate with each other.

<Flow of Processing>

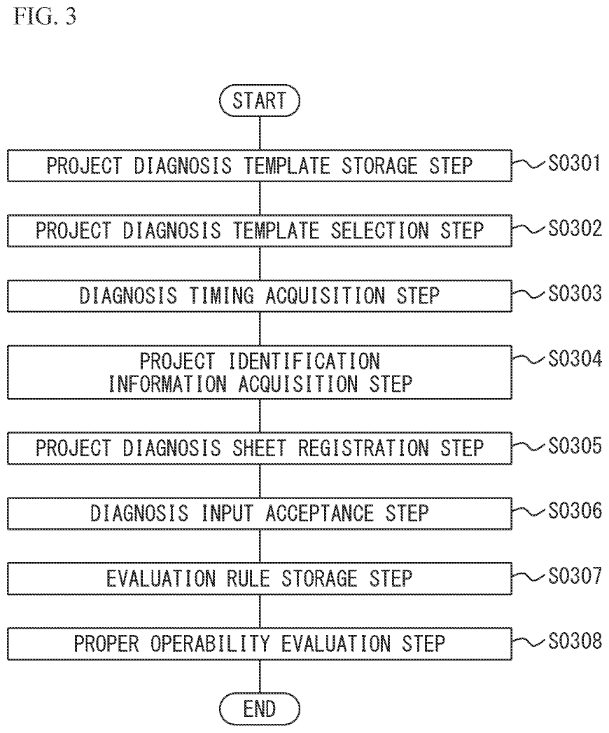

FIG. 3 is a diagram illustrating a flow of processing when the project diagnosis DB system according to the present embodiment is used. The flow of processing of the present embodiment is an operation method of the project diagnosis DB system which is a computer having a project diagnosis template storage step (S0301), a project diagnosis template selection step (S0302), a diagnosis timing acquisition step (S0303), a project identification information acquisition step (S0304), a project diagnosis sheet registration step (S0305), a diagnosis input acceptance step (S0306), an evaluation rule storage step (S0307), and a proper operability evaluation step (S0308). In addition, a project diagnosis sheet generation step, a timing registration step, and a diagnosis timing judgment step may be provided, and the same applies to other embodiments. Each step will be described below.

The “project diagnosis template storage step” is a step of storing the plurality of project diagnosis templates composed of diagnosis sentences in predetermined sentences for checking the proper operability of the project.

The “project diagnosis template selection step” is a step of allowing the user to select the project diagnosis template for checking the proper operability of the project being operated.

The “diagnosis timing acquisition step” is a step of acquiring the diagnosis timing which is the timing for diagnosing the project in order to associate it with the project diagnosis sheet to be described later.

The “project identification information acquisition step” is a step of acquiring the project identification information, which is the identification information of the project to be diagnosed, in order to associate it with the project diagnosis sheet described later.

The “project diagnosis sheet registration step” is a step of registering the selected diagnosis template as the project diagnosis sheet in association with information to be associated such as a diagnostician and a diagnosis timing.

The “diagnosis input acceptance step” is a step of accepting the diagnosis input which is the input for judging whether the project is properly operated for each diagnosis item of the project diagnosis sheet.

The “evaluation rule storage step” is a step of storing the evaluation rule for evaluating the accepted diagnosis input. The evaluation rule includes a weight for each evaluation item. For example, “scope” and “quality” in the evaluation items are more important than “procurement” and “human resources”.

The “proper operability evaluation step” is a step of evaluating the proper operability of the project based on the stored evaluation rule and the input diagnosis result.

The “project diagnosis sheet generation step” may be included in addition to the above. The “project diagnosis sheet generation step” is a step of generating the project diagnosis sheet including the selected diagnosis template based on the selected diagnosis template.

The “timing registration step” is a step of registering a diagnosis timing, which is a timing for diagnosing the project using the registered project diagnosis sheet, in association with the project identification information.

The “diagnosis timing judgment step” is a step of judging whether the registered diagnosis timing has arrived.

### Second Embodiment

In addition to the above-described embodiments, this embodiment provides a project diagnosis DB system having a function of acquiring diagnostician identification information for identifying a diagnostician who executes a diagnosis input into a diagnosis sheet in order to associate it with the project diagnosis sheet.

<Functional Configuration>

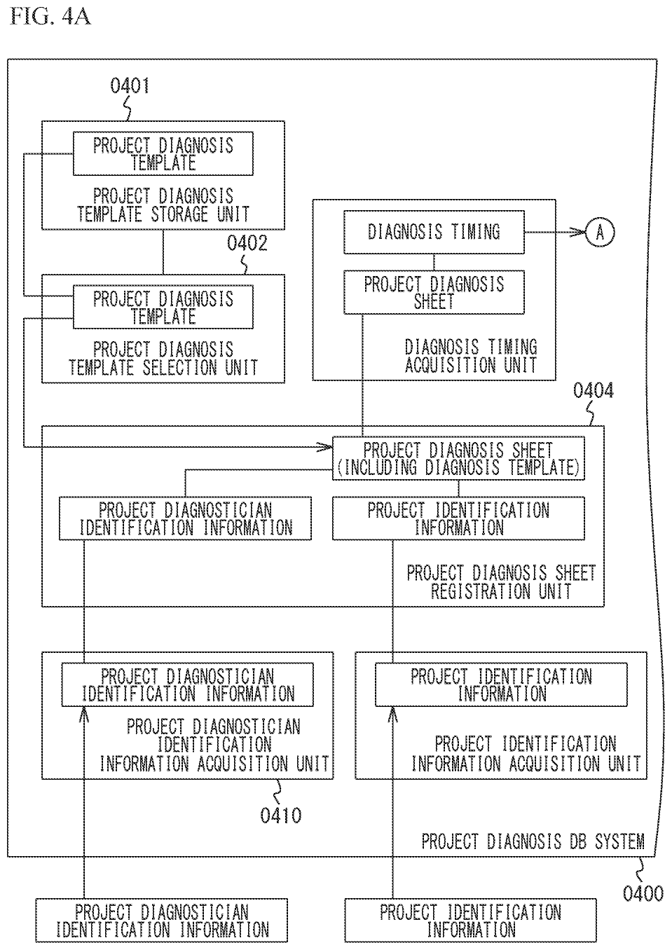

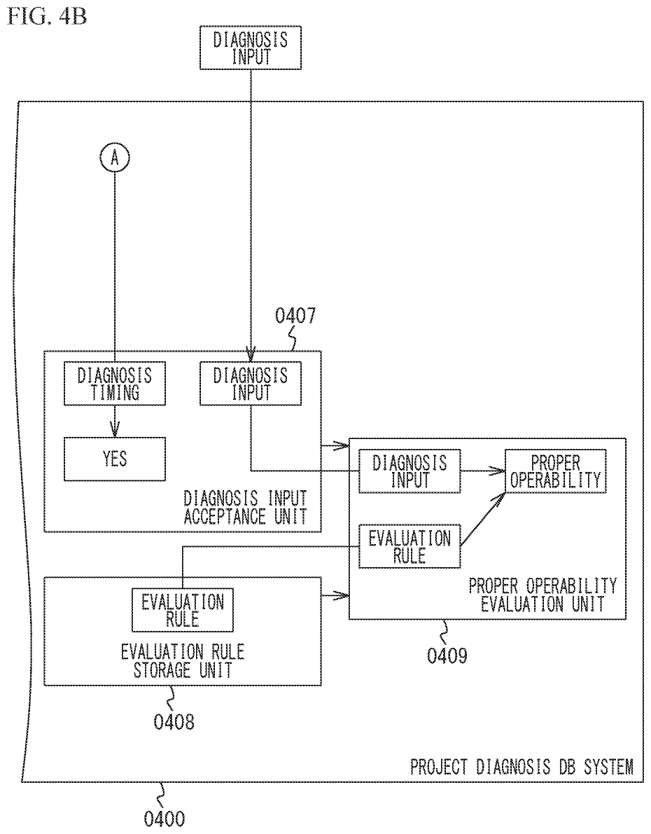

FIGS. 4A and 4B are diagrams illustrating the functional configuration according to the present embodiment. The project diagnosis DB system (0400) of the present embodiment has a project diagnosis template storage unit (0401), a project diagnosis template selection unit (0402), a project diagnosis sheet registration unit (0404), a diagnosis input acceptance unit (0407), an evaluation rule storage unit (0408), and a proper operability evaluation unit (0409) as in the first embodiment, and further has a project diagnostician identification information acquisition unit (0410). The description will be made except for the functions already described.

The “project diagnostician identification information acquisition unit” has a function of acquiring diagnostician identification information for identifying a diagnostician who executes a diagnosis input into the diagnosis sheet in order to associate it with the project diagnosis sheet.

<Hardware Configuration>

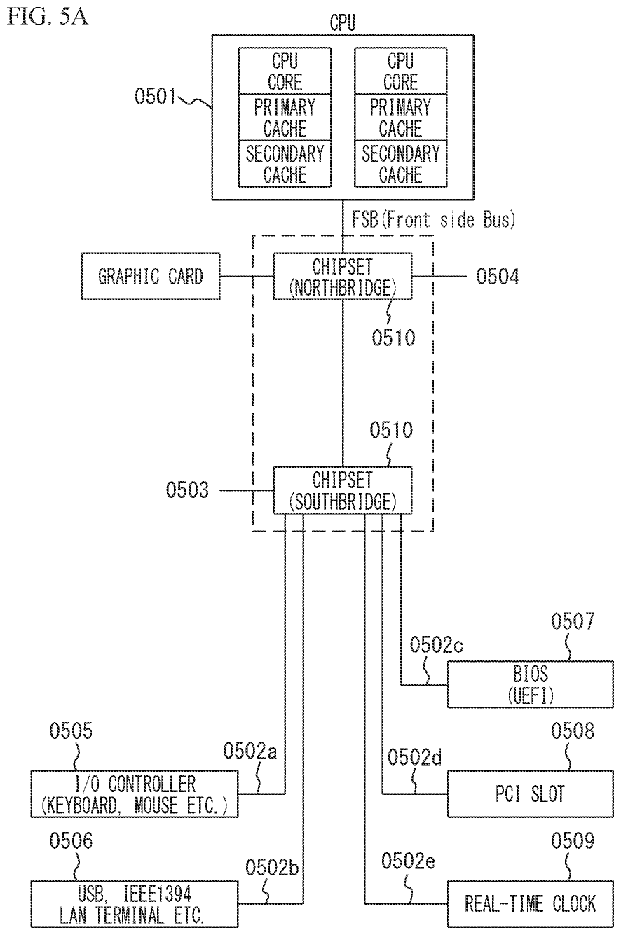

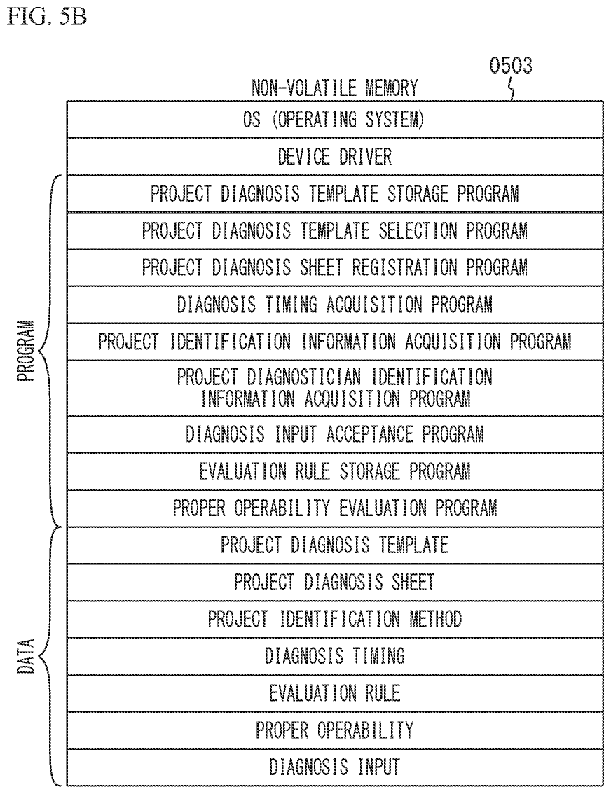

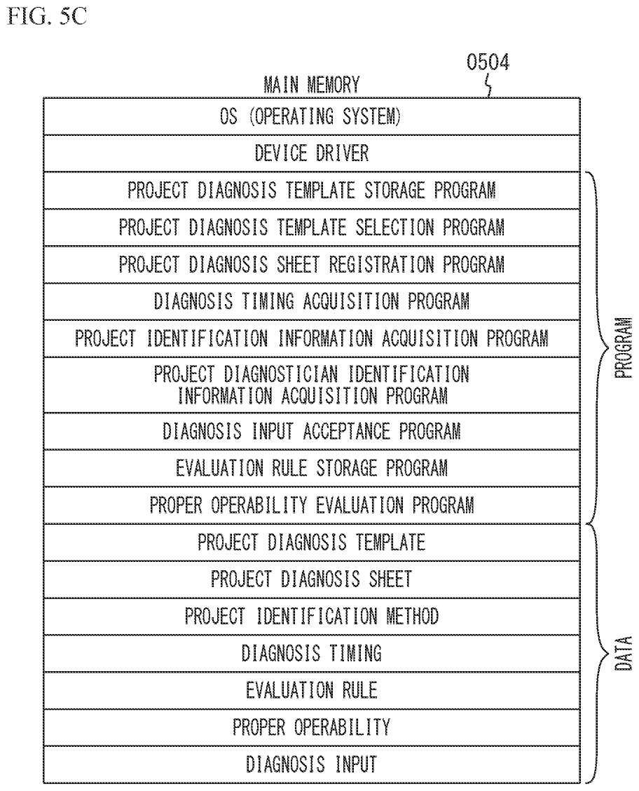

FIGS. 5A to 5C are diagrams illustrating a hardware configuration of the project diagnosis DB system according to the present embodiment. As illustrated in FIGS. 5A to 5C, the computer includes a chip set (0510), a CPU (0501), a non-volatile memory (0503), a main memory (0504), various buses (0502a to 0502e), a BIOS (0507), various interfaces (0505, 0506, 0508), a real-time clock (0509), and the like, which are configured on a motherboard. They work in conjunction with operating systems, device drivers and programs. Various programs and various data constituting the present embodiment are configured to execute various processes by efficiently utilizing these hardware resources.

Here, the “main memory” reads out programs for performing various processes in order to cause the “CPU” to execute the programs, and at the same time provides work areas for the programs. A plurality of addresses are allocated to each of the “main memory” and the “HDD”, and programs executed by the “CPU” can exchange data with each other and perform processing by specifying and accessing the addresses.

As illustrated in FIGS. 5A to 5C, the nonvolatile memory stores: a “project diagnosis template storage program” for storing a plurality of project diagnosis templates composed of diagnosis sentences in predetermined sentences for checking the proper operability of the project; a “project diagnosis template selection program” for allowing the user to select a project diagnosis template for checking the proper operability of the project being operated; a “diagnosis timing acquisition program” for acquiring a diagnosis timing which is a timing for diagnosing a project in order to associate it with the project diagnosis sheet to be described later; a “project identification information acquisition program” for acquiring project identification information, which is identification information of the project to be diagnosed, in order to associate the project identification information with the project diagnosis sheet to be described later, a “project diagnosis sheet registration program” for registering a selected diagnosis template as the project diagnosis sheet in association with information to be associated; a “diagnosis input acceptance program” for accepting a diagnosis input which is an input for judging whether the project is properly operated for each diagnosis item of the project diagnosis sheet; an “evaluation rule storing program” for storing evaluation rules to evaluate the accepted diagnosis input; and a “proper operability evaluation program” for evaluating the proper operability of the project based on the stored evaluation rule and the inputted diagnosis input. These programs are read into the main memory based on the execution instruction of a series of programs, and these programs are executed based on an operation start instruction. In this computer, the non-volatile memory, the main memory, the CPU, and the interface (for example, a display, a keyboard, communication, etc.) are connected to the bus lines so that they can communicate with each other. Further, in addition to the first embodiment, there is provided a “project diagnostician identification information acquisition program” for acquiring diagnostician identification information for identifying the diagnostician who executes the diagnosis input into the diagnosis sheet in order to associate it with the project diagnosis sheet.

<Flow of Processing>

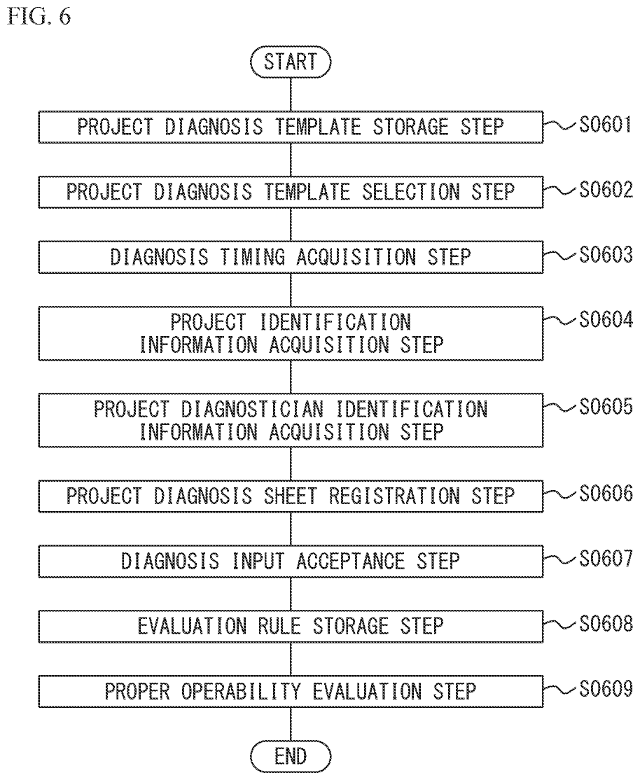

FIG. 6 is a diagram illustrating a flow of processing when the project diagnosis DB system according to the present embodiment is used. The flow of processing of the present embodiment is an operation method of the project diagnosis DB system which is a computer having a project diagnosis template storage step (S0601), a project diagnosis template selection step (S0602), a diagnosis timing acquisition step (S0603), a project identification information acquisition step (S0604), a project diagnostician identification information acquisition step (S0605), a project diagnosis sheet registration step (S0606), a diagnosis input acceptance step (S0607), an evaluation rule storage step (S0608), and a proper operability evaluation step (S0609). The steps other than the project diagnostician identification information acquisition step are the same as those in the first embodiment.

The “project diagnostician identification information acquisition step” is a step of acquiring diagnostician identification information for identifying the diagnostician who executes the diagnosis input into the diagnosis sheet in order to associate it with the project diagnosis sheet.

### Third Embodiment

In addition to the above-described embodiments, the present embodiment provides a project diagnosis DB system having a function of storing a project diagnosis sheet associated with a plurality of project identification information.

<Functional Configuration>

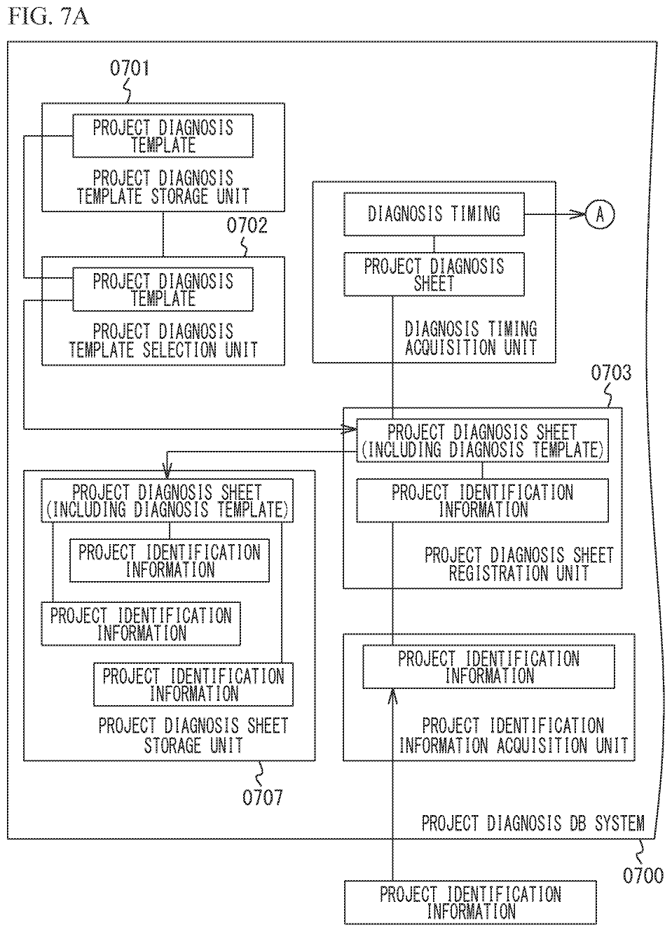

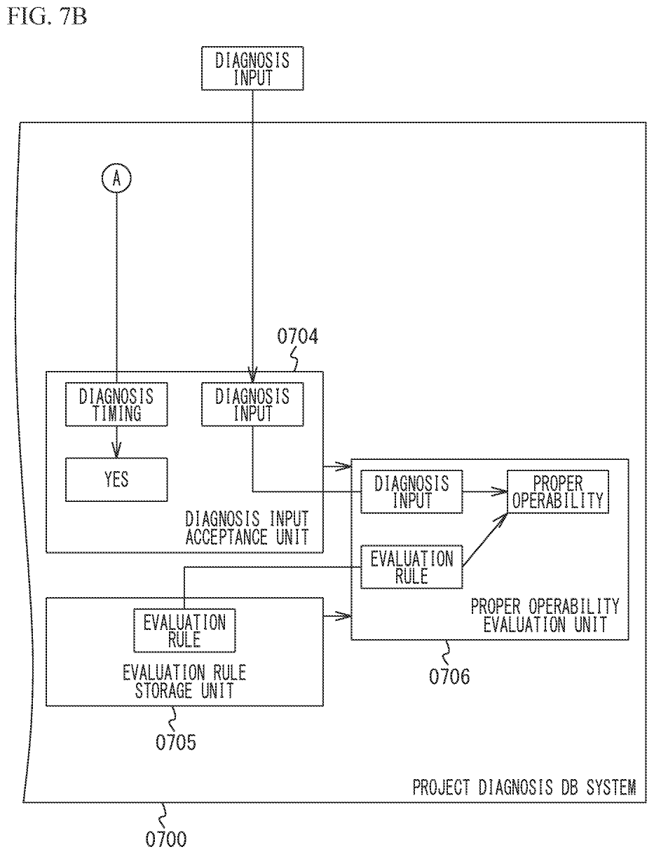

FIGS. 7A and 7B are diagrams illustrating the functional configuration according to the present embodiment. The project diagnosis DB system (0700) of the present embodiment has a project diagnosis template storage unit (0701), a project diagnosis template selection unit (0702), a project diagnosis sheet registration unit (0703), a diagnosis input acceptance unit (0704), an evaluation rule storage unit (0705), and a proper operability evaluation unit (0706) as in the first embodiment, and further has a project diagnosis sheet storage unit (0707) storing a project diagnosis sheet associated with a plurality of project identification information. The description will be made except for the functions already described.

The “project diagnosis sheet storage unit” has a function of storing the project diagnosis sheet associated with the plurality of project identification information.

<Hardware Configuration>

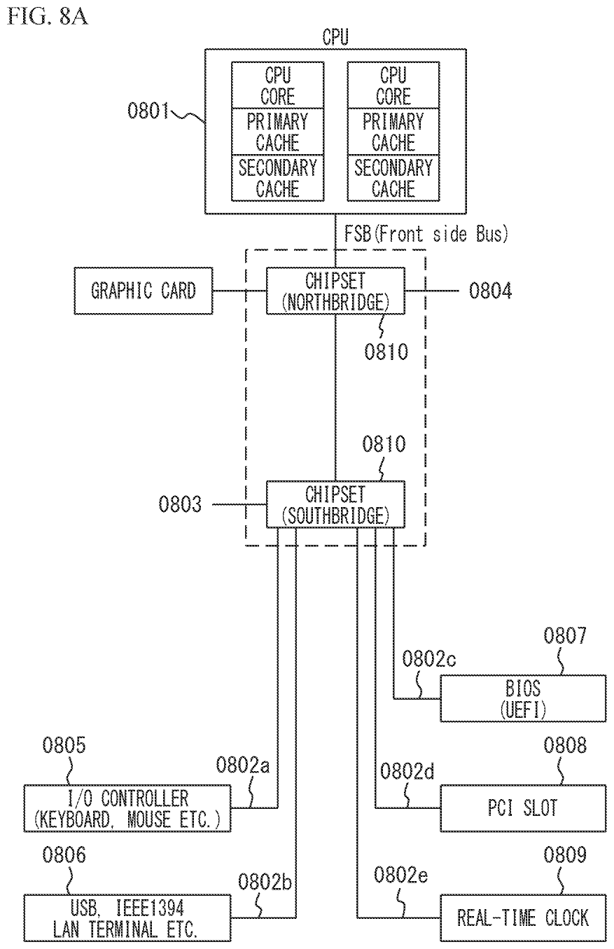

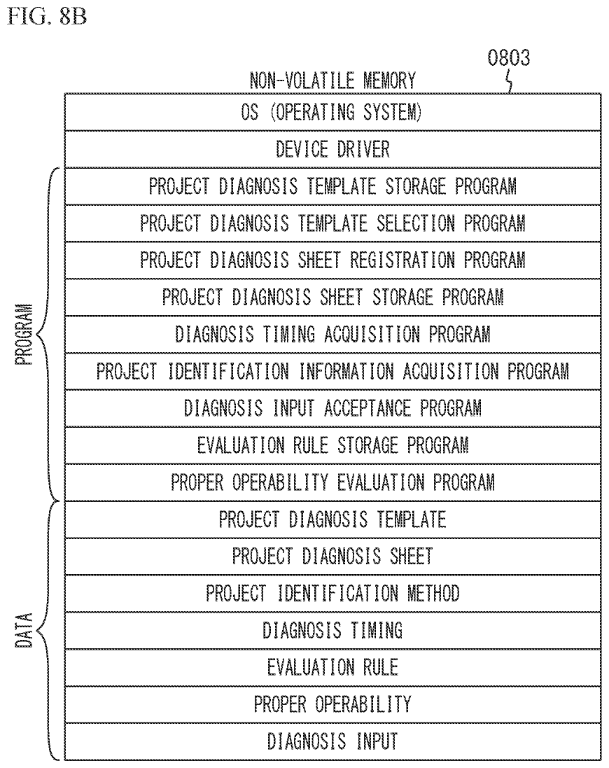

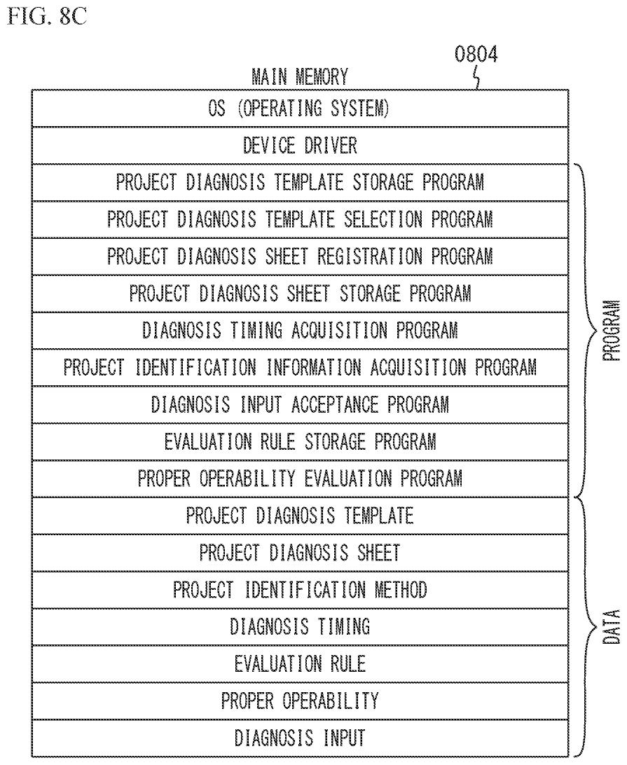

FIGS. 8A to 8C are diagrams illustrating a hardware configuration of the project diagnosis DB system according to the present embodiment. As illustrated in FIGS. 8A to 8C, the computer includes a chip set (0810), a CPU (0801), a non-volatile memory (0803), a main memory (0804), various buses (0802a to 0802e), a BIOS (0807), various interfaces (0805, 0806, 0808), a real-time clock (0809), and the like, which are configured on a motherboard. They work in conjunction with operating systems, device drivers and programs. Various programs and various data constituting the present embodiment are configured to execute various processes by efficiently utilizing these hardware resources.

Here, the “main memory” reads out programs for performing various processes in order to cause the “CPU” to execute the programs, and at the same time provides work areas for the programs. A plurality of addresses are allocated to each of the “main memory” and the “HDD”, and programs executed by the “CPU” can exchange data with each other and perform processing by specifying and accessing the addresses.

As illustrated in FIGS. 8A to 8C, the nonvolatile memory stores: a “project diagnosis template storage program” for storing a plurality of project diagnosis templates composed of diagnosis sentences in predetermined sentences for checking the proper operability of the project; a “project diagnosis template selection program” for allowing the user to select a project diagnosis template for checking the proper operability of the project being operated; a “diagnosis timing acquisition program” for acquiring a diagnosis timing which is a timing for diagnosing a project in order to associate it with the project diagnosis sheet to be described later; a “project identification information acquisition program” for acquiring project identification information, which is identification information of the project to be diagnosed, in order to associate the project identification information with the project diagnosis sheet to be described later, a “project diagnosis sheet registration program” for registering a selected diagnosis template as the project diagnosis sheet in association with information to be associated; a “diagnosis input acceptance program” for accepting a diagnosis input which is an input for judging whether the project is properly operated for each diagnosis item of the project diagnosis sheet; an “evaluation rule storing program” for storing evaluation rules to evaluate the accepted diagnosis input; and a “proper operability evaluation program” for evaluating the proper operability of the project based on the stored evaluation rule and the inputted diagnosis input. These programs are read into the main memory based on the execution instruction of a series of programs, and these programs are executed based on an operation start instruction. In this computer, the non-volatile memory, the main memory, the CPU, and the interface (for example, a display, a keyboard, communication, etc.) are connected to the bus lines so that they can communicate with each other. Further, in addition to the first embodiment, there is provided a “project diagnosis sheet storage program” storing the project diagnosis sheet associated with the plurality of project identification information.

<Flow of Processing>

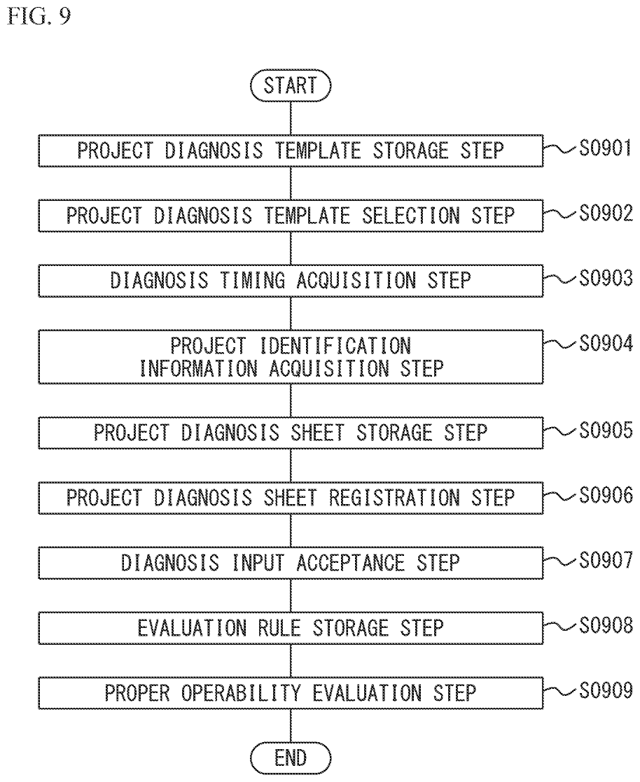

FIG. 9 is a diagram illustrating a flow of processing when the project diagnosis DB system according to the present embodiment is used. The flow of processing of the present embodiment is an operation method of the project diagnosis DB system which is a computer having a project diagnosis template storage step (S0901), a project diagnosis template selection step (S0902), a diagnosis timing acquisition step (S0903), a project identification information acquisition step (S0904), a project diagnosis sheet storage step (S0905), a project diagnosis sheet registration step (S0906), a diagnosis input acceptance step (S0907), an evaluation rule storage step (S0908), and a proper operability evaluation step (S0909). The steps other than the project diagnosis sheet storage step are the same as those in the first embodiment.

The “project diagnosis sheet storage step” is a step of storing the project diagnosis sheet associated with the plurality of project identification information.

### Fourth Embodiment

In addition to the above-described embodiments, this embodiment provides a project diagnosis DB system having a function for registering at least one of a project startup timing, a project requirement definition timing, a project basic design timing, a project implementation timing, a project integration test timing, a project system test timing, a project system operation test timing, a project system migration timing and a project termination timing as a timing for accepting an input of a diagnosis result when a project includes system design.

<Functional Configuration>

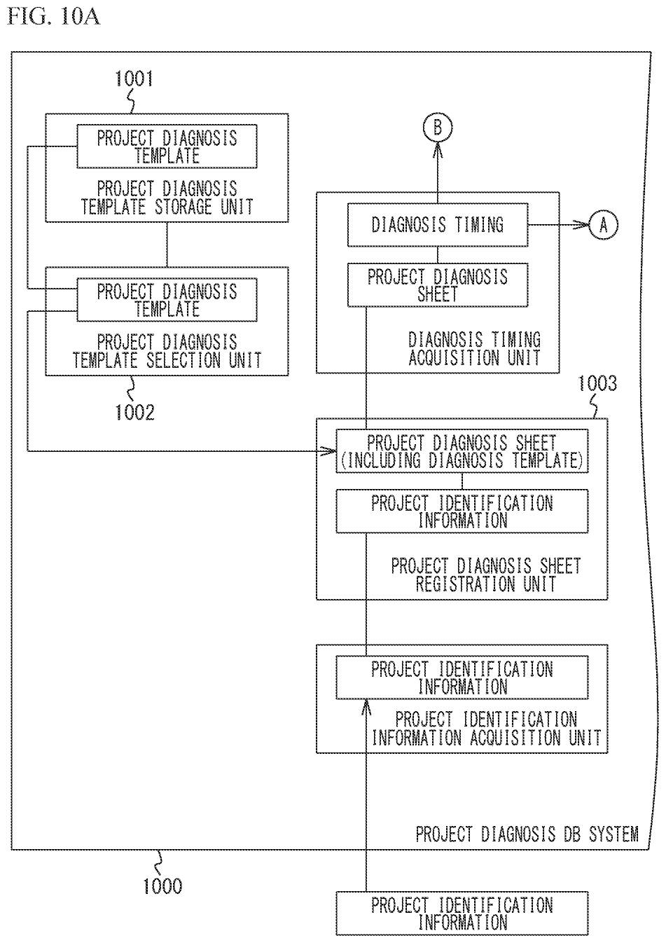

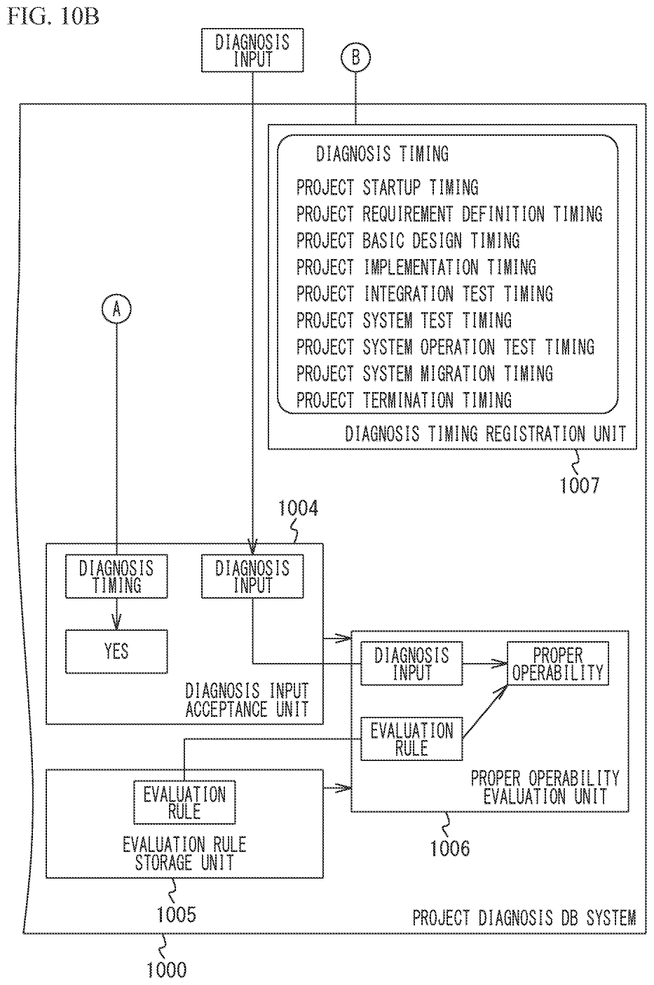

FIGS. 10A and 10B are diagrams illustrating the functional configuration according to the present embodiment. The project diagnosis DB system (1000) of the present embodiment has a project diagnosis template storage unit (1001), a project diagnosis template selection unit (1002), a project diagnosis sheet registration unit (1003), a diagnosis input acceptance unit (1004), an evaluation rule storage unit (1005), and a proper operability evaluation unit (1006) as in the first embodiment, and further has a timing registration unit (1007). The description will be made except for the functions already described.

The “timing registration unit” has a function of registering at least one of the project startup timing, the project requirements definition timing, the project basic design timing, the project implementation timing, the project integration test timing, the project system test timing, the project system operation test timing, the project system migration timing, and the project termination timing as the timing for accepting the input of the diagnosis result when the project includes the system design.

<Hardware Configuration>

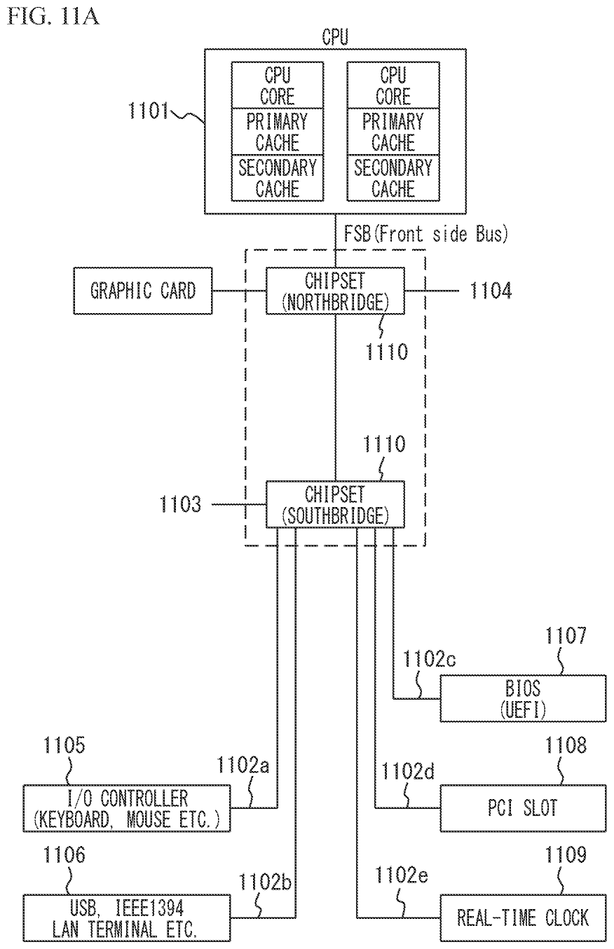

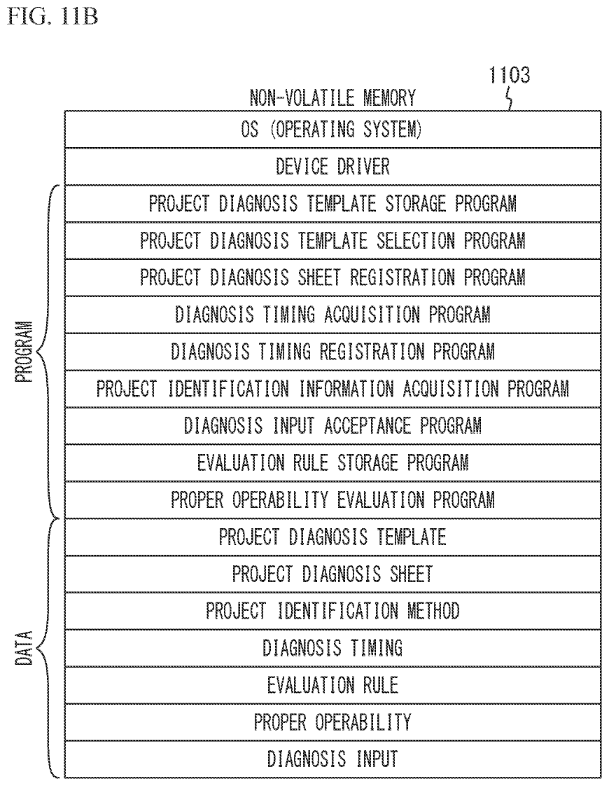

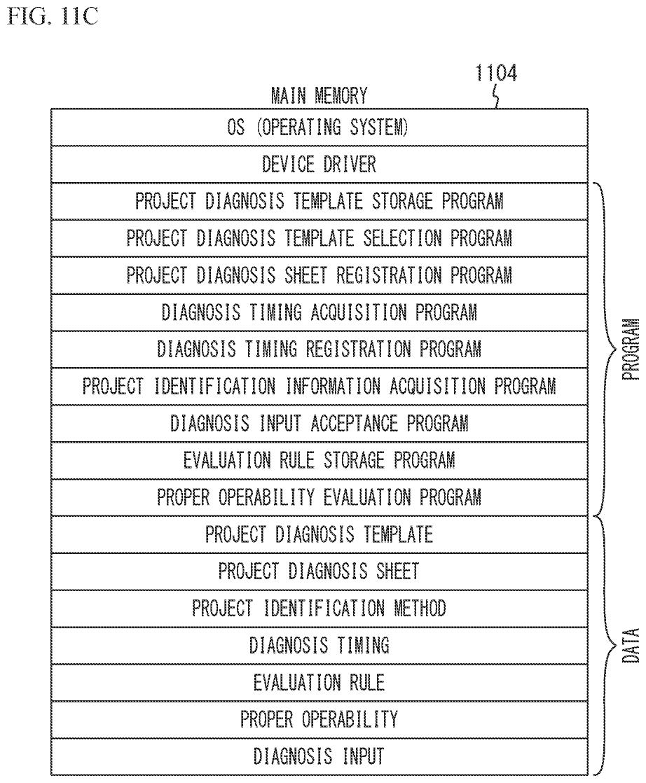

FIGS. 11A to 11C are diagrams illustrating a hardware configuration of the project diagnosis DB system according to the present embodiment. As illustrated in FIGS. 11A to 11C, the computer includes a chip set (1110), a CPU (1101), a non-volatile memory (1103), a main memory (1104), various buses (1102a to 1102e), a BIOS (1107), various interfaces (1105, 1106, 1108), a real-time clock (1109), and the like, which are configured on a motherboard. They work in conjunction with operating systems, device drivers and programs. Various programs and various data constituting the present embodiment are configured to execute various processes by efficiently utilizing these hardware resources.

Here, the “main memory” reads out programs for performing various processes in order to cause the “CPU” to execute the programs, and at the same time provides work areas for the programs. A plurality of addresses are allocated to each of the “main memory” and the “HDD”, and programs executed by the “CPU” can exchange data with each other and perform processing by specifying and accessing the addresses.

As illustrated in FIGS. 11A to 11C, the nonvolatile memory stores: a “project diagnosis template storage program” for storing a plurality of project diagnosis templates composed of diagnosis sentences in predetermined sentences for checking the proper operability of the project; a “project diagnosis template selection program” for allowing the user to select a project diagnosis template for checking the proper operability of the project being operated; a “diagnosis timing acquisition program” for acquiring a diagnosis timing which is a timing for diagnosing a project in order to associate it with the project diagnosis sheet to be described later; a “project identification information acquisition program” for acquiring project identification information, which is identification information of the project to be diagnosed, in order to associate the project identification information with the project diagnosis sheet to be described later, a “project diagnosis sheet registration program” for registering a selected diagnosis template as the project diagnosis sheet in association with information to be associated; a “diagnosis input acceptance program” for accepting a diagnosis input which is an input for judging whether the project is properly operated for each diagnosis item of the project diagnosis sheet; an “evaluation rule storing program” for storing evaluation rules to evaluate the accepted diagnosis input; and a “proper operability evaluation program” for evaluating the proper operability of the project based on the stored evaluation rule and the inputted diagnosis input. These programs are read into the main memory based on the execution instruction of a series of programs, and these programs are executed based on an operation start instruction. In this computer, the non-volatile memory, the main memory, the CPU, and the interface (for example, a display, a keyboard, communication, etc.) are connected to the bus lines so that they can communicate with each other. Further, in addition to the first embodiment, there is provided a “timing registration program” for registering at least one of the project startup timing, the project requirements definition timing, the project basic design timing, the project implementation timing, the project integration test timing, the project system test timing, the project system operation test timing, the project system migration timing, and the project termination timing as the timing for accepting the input of the diagnosis result when the project includes the system design.

<Flow of Processing>

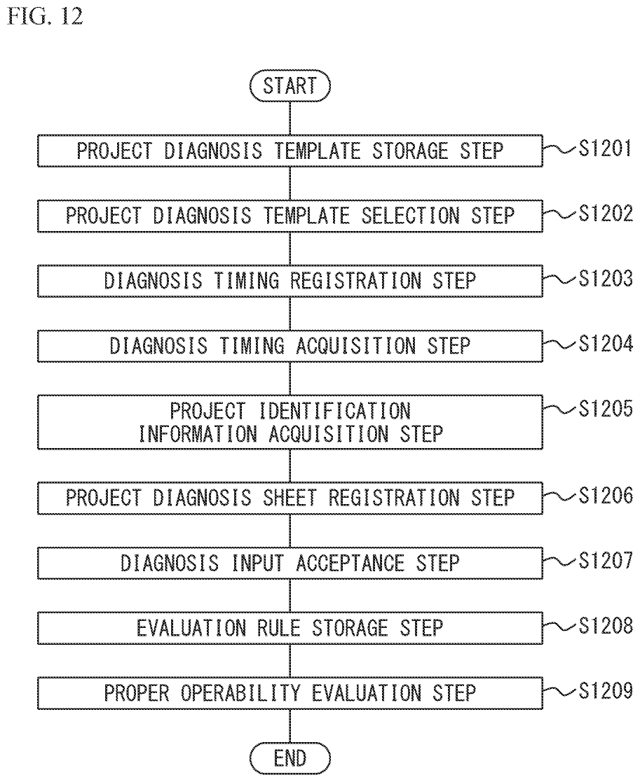

FIG. 12 is a diagram illustrating a flow of processing when the project diagnosis DB system according to the present embodiment is used. The flow of processing of the present embodiment is an operation method of the project diagnosis DB system which is a computer having a project diagnosis template storage step (S1201), a project diagnosis template selection step (S1202), a diagnosis timing registration step (S1203), a diagnosis timing acquisition step (S1204), a project identification information acquisition step (S1205), a project diagnosis sheet registration step (S1206), a diagnosis input acceptance step (S1207), an evaluation rule storage step (S1208), and a proper operability evaluation step (S1209). The steps other than the diagnosis timing registration step are the same as those in the first embodiment.

The “timing registration step” is a step of registering at least one of the project startup timing, the project requirements definition timing, the project basic design timing, the project implementation timing, the project integration test timing, the project system test timing, the project system operation test timing, the project system migration timing, and the project termination timing as the timing for accepting the input of the diagnosis result when the project includes the system design.

### Fifth Embodiment

In addition to the above-described embodiments, the present embodiment provides a project diagnosis DB system having a function of storing the evaluation result of the proper operability of the project in association with the project identification information.

<Functional Configuration>

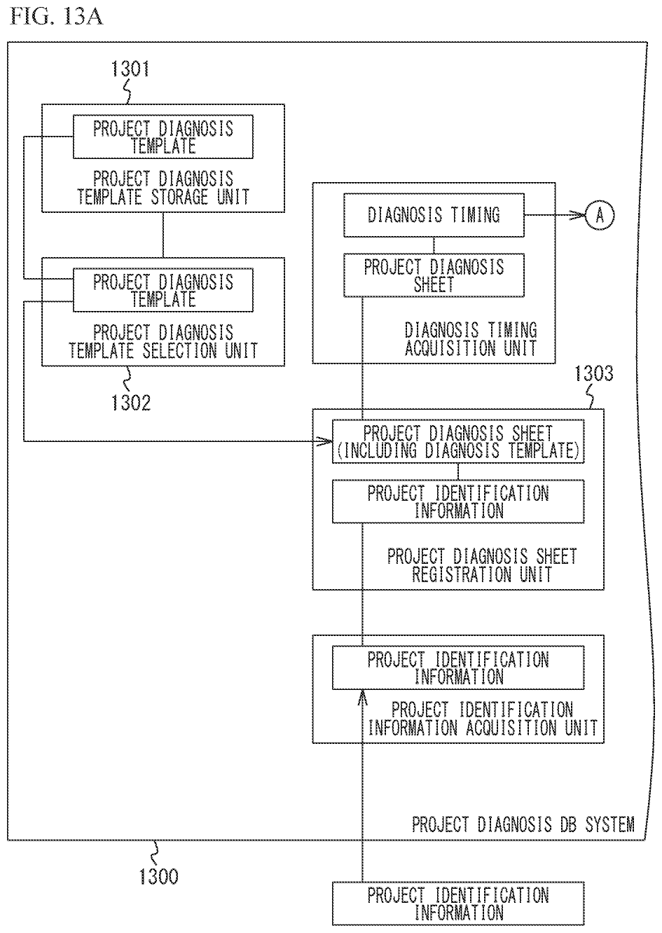

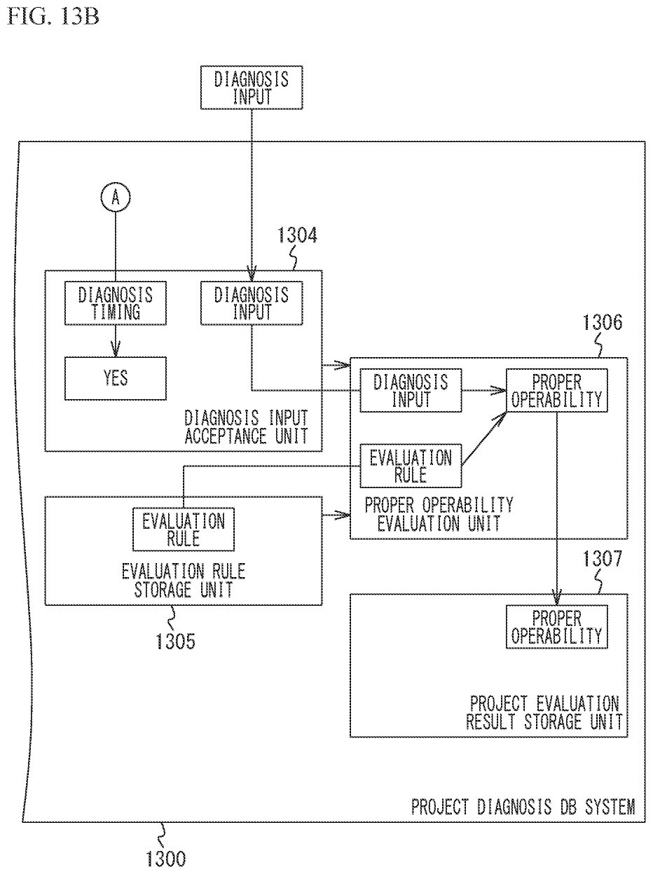

FIGS. 13A and 13B are diagrams illustrating the functional configuration according to the present embodiment. The project diagnosis DB system (1300) of the present embodiment has a project diagnosis template storage unit (1301), a project diagnosis template selection unit (1302), a project diagnosis sheet registration unit (1303), a diagnosis input acceptance unit (1304), an evaluation rule storage unit (1305), and a proper operability evaluation unit (1306) as in the first embodiment, and further has a project evaluation result storage unit (1307). The description will be made except for the functions already described.

The “project evaluation result storage unit” has a function of storing the evaluation result of the proper operability of the project in association with the project identification information.

<Hardware Configuration>

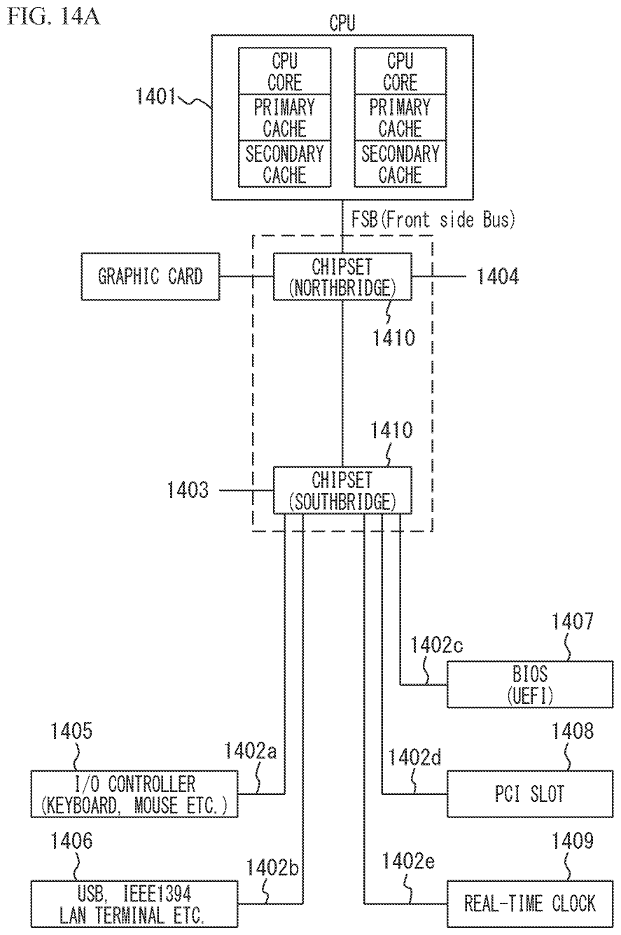

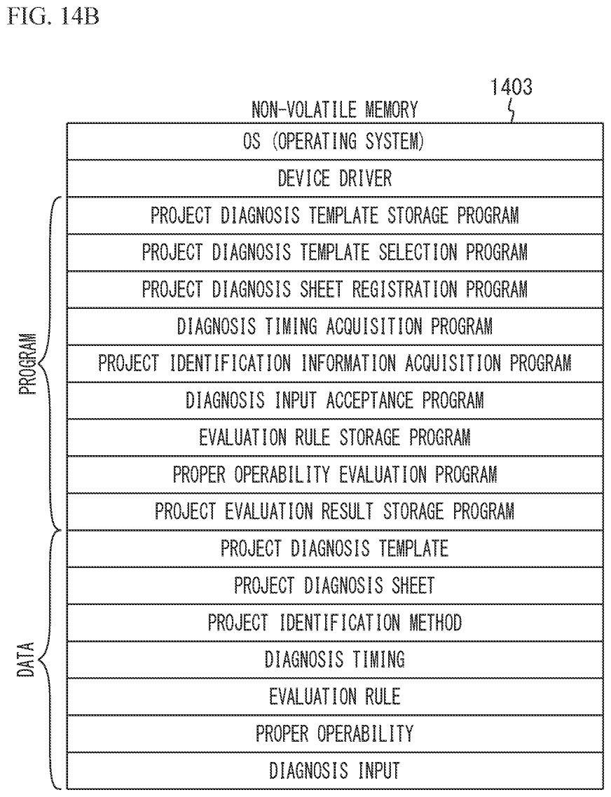

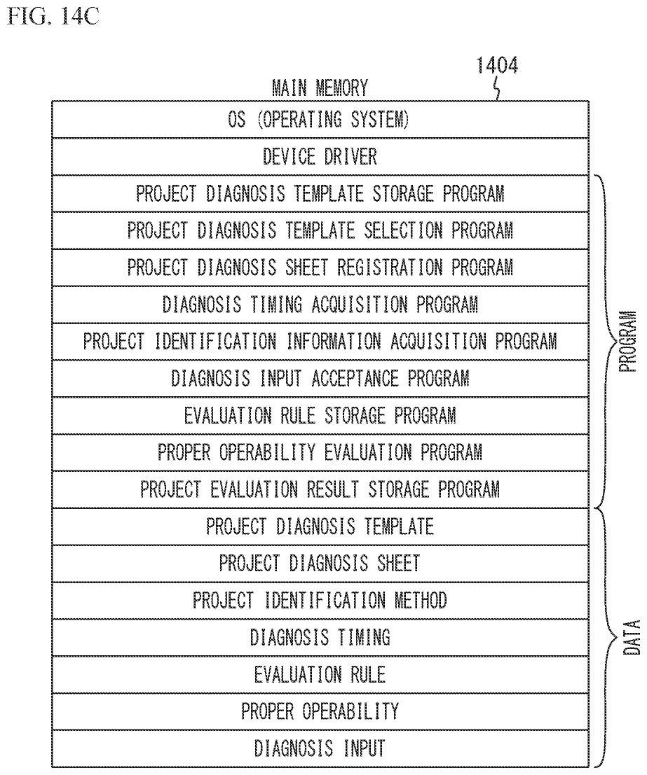

FIGS. 14A to 14C are diagrams illustrating a hardware configuration of the project diagnosis DB system according to the present embodiment. As illustrated in FIGS. 14A to 14C, the computer includes a chip set (1410), a CPU (1401), a non-volatile memory (1403), a main memory (1404), various buses (1402a to 1402e), a BIOS (1407), various interfaces (1405, 1406, 1408), a real-time clock (1409), and the like, which are configured on a motherboard. They work in conjunction with operating systems, device drivers and programs. Various programs and various data constituting the present embodiment are configured to execute various processes by efficiently utilizing these hardware resources.

Here, the “main memory” reads out programs for performing various processes in order to cause the “CPU” to execute the programs, and at the same time provides work areas for the programs. A plurality of addresses are allocated to each of the “main memory” and the “HDD”, and programs executed by the “CPU” can exchange data with each other and perform processing by specifying and accessing the addresses.

As illustrated in FIG. 14, the nonvolatile memory stores: a “project diagnosis template storage program” for storing a plurality of project diagnosis templates composed of diagnosis sentences in predetermined sentences for checking the proper operability of the project; a “project diagnosis template selection program” for allowing the user to select a project diagnosis template for checking the proper operability of the project being operated; a “diagnosis timing acquisition program” for acquiring a diagnosis timing which is a timing for diagnosing a project in order to associate it with the project diagnosis sheet to be described later; a “project identification information acquisition program” for acquiring project identification information, which is identification information of the project to be diagnosed, in order to associate the project identification information with the project diagnosis sheet to be described later, a “project diagnosis sheet registration program” for registering a selected diagnosis template as the project diagnosis sheet in association with information to be associated; a “diagnosis input acceptance program” for accepting a diagnosis input which is an input for judging whether the project is properly operated for each diagnosis item of the project diagnosis sheet; an “evaluation rule storing program” for storing evaluation rules to evaluate the accepted diagnosis input; and a “proper operability evaluation program” for evaluating the proper operability of the project based on the stored evaluation rule and the inputted diagnosis input. These programs are read into the main memory based on the execution instruction of a series of programs, and these programs are executed based on an operation start instruction. In this computer, the non-volatile memory, the main memory, the CPU, and the interface (for example, a display, a keyboard, communication, etc.) are connected to the bus lines so that they can communicate with each other. Further, in addition to the first embodiment, there is provided a “project evaluation result storage program” storing the evaluation result of the proper operability of the project in association with the project identification information.

<Flow of Processing>

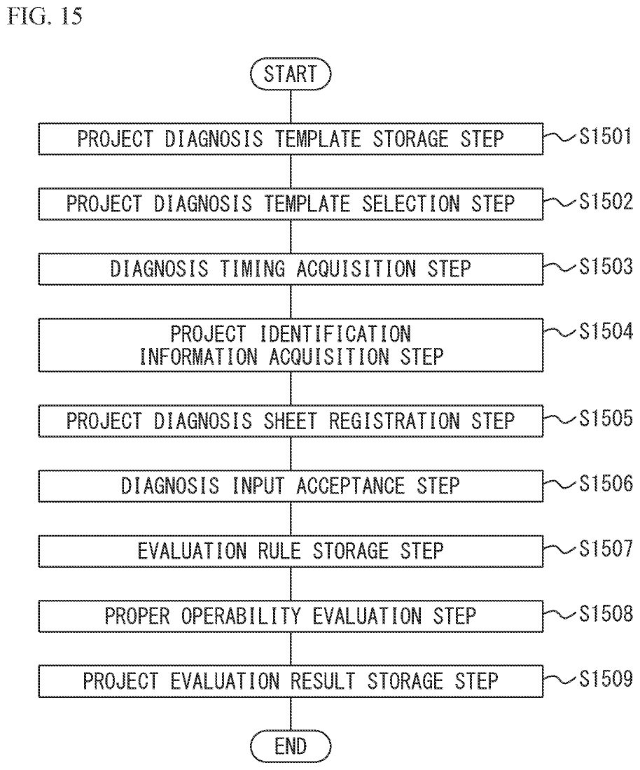

FIG. 15 is a diagram illustrating a flow of processing when the project diagnosis DB system according to the present embodiment is used. The flow of processing of the present embodiment is an operation method of the project diagnosis DB system which is a computer having a project diagnosis template storage step (S1501), a project diagnosis template selection step (S1502), a diagnosis timing acquisition step (S1503), a project identification information acquisition step (S1504), a project diagnosis sheet registration step (S1505), a diagnosis input acceptance step (S1506), an evaluation rule storage step (S1507), a proper operability evaluation step (S1508), and a project evaluation result storage step (S1509). The steps other than the project evaluation result storage step are the same as those in the first embodiment.

The “project evaluation result storage step” is a step of storing the evaluation result of the proper operability of the project in association with the project identification information.

### Sixth Embodiment

In addition to the above-described embodiments, the present embodiment provides a project diagnosis DB system having a function of searching for another project evaluation result based on a project evaluation result. This function is used to search for another project evaluation result that are common to one project evaluation result in terms of a phase, a scale, and a diagnostician.

<Functional Configuration>

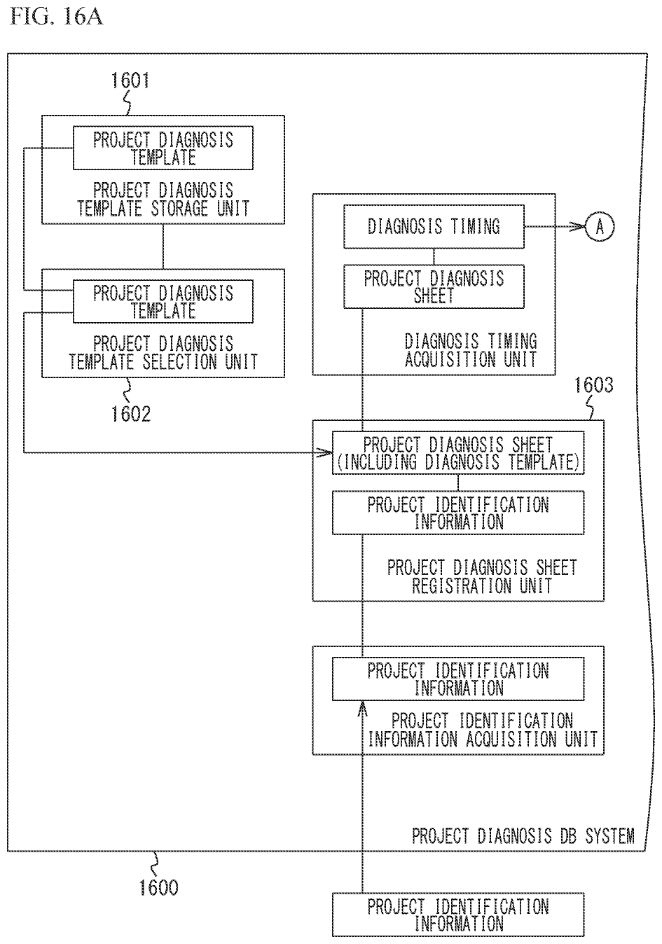

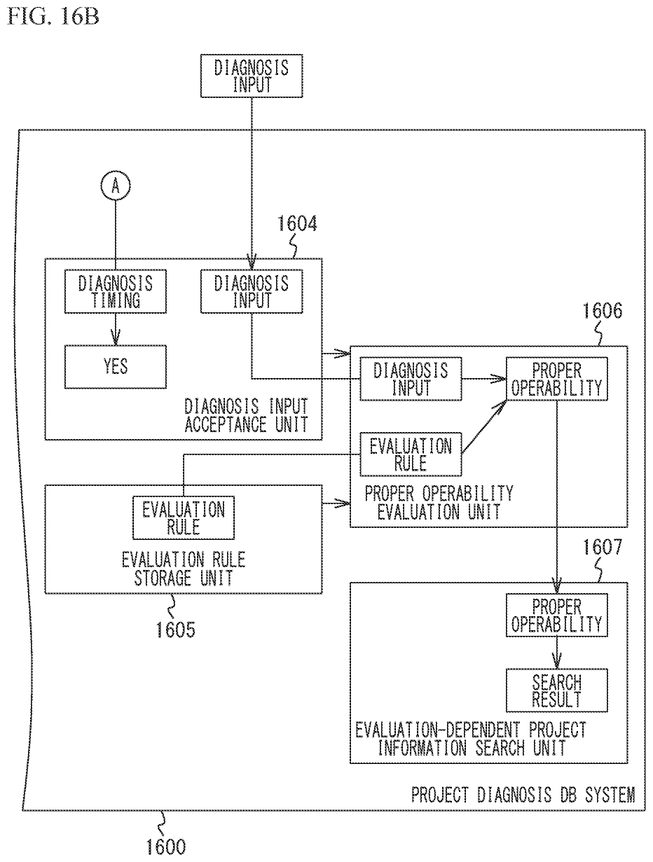

FIGS. 16A and 16B are diagrams illustrating the functional configuration according to the present embodiment. The project diagnosis DB system (1600) of the present embodiment has a project diagnosis template storage unit (1601), a project diagnosis template selection unit (1602), a project diagnosis sheet registration unit (1603), a diagnosis input acceptance unit (1604), an evaluation rule storage unit (1605), and a proper operability evaluation unit (1606) as in the first embodiment, and further has an evaluation-dependent project information search unit (1607). The description will be made except for the functions already described.

The “evaluation-dependent project information search unit” has a function of searching for another project evaluation result based on the project evaluation result.

<Hardware Configuration>

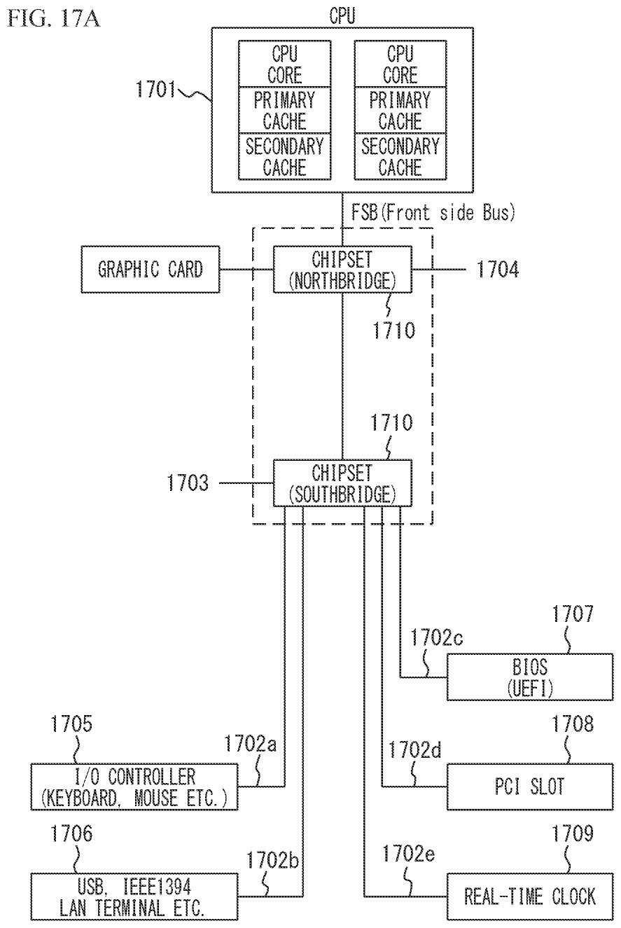

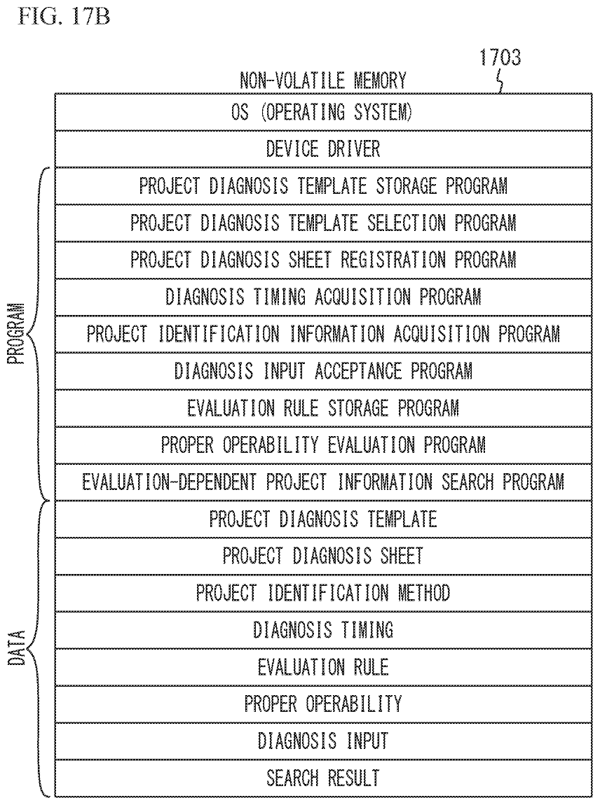

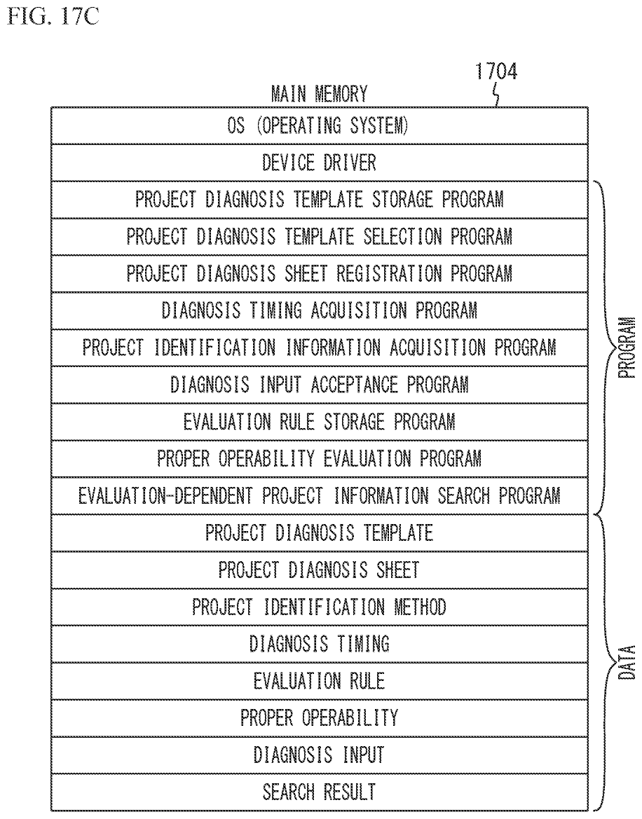

FIGS. 17A to 17C are diagrams illustrating a hardware configuration of the project diagnosis DB system according to the present embodiment. As illustrated in FIGS. 17A to 17C, the computer includes a chip set (1710), a CPU (1701), a non-volatile memory (1703), a main memory (1704), various buses (1702a to 1702e), a BIOS (1707), various interfaces (1705, 1706, 1708), a real-time clock (1709), and the like, which are configured on a motherboard. They work in conjunction with operating systems, device drivers and programs. Various programs and various data constituting the present embodiment are configured to execute various processes by efficiently utilizing these hardware resources.

Here, the “main memory” reads out programs for performing various processes in order to cause the “CPU” to execute the programs, and at the same time provides work areas for the programs. A plurality of addresses are allocated to each of the “main memory” and the “HDD”, and programs executed by the “CPU” can exchange data with each other and perform processing by specifying and accessing the addresses.

As illustrated in FIGS. 17A to 17C, the nonvolatile memory stores: a “project diagnosis template storage program” for storing a plurality of project diagnosis templates composed of diagnosis sentences in predetermined sentences for checking the proper operability of the project; a “project diagnosis template selection program” for allowing the user to select a project diagnosis template for checking the proper operability of the project being operated; a “diagnosis timing acquisition program” for acquiring a diagnosis timing which is a timing for diagnosing a project in order to associate it with the project diagnosis sheet to be described later; a “project identification information acquisition program” for acquiring project identification information, which is identification information of the project to be diagnosed, in order to associate the project identification information with the project diagnosis sheet to be described later, a “project diagnosis sheet registration program” for registering a selected diagnosis template as the project diagnosis sheet in association with information to be associated; a “diagnosis input acceptance program” for accepting a diagnosis input which is an input for judging whether the project is properly operated for each diagnosis item of the project diagnosis sheet; an “evaluation rule storing program” for storing evaluation rules to evaluate the accepted diagnosis input; and a “proper operability evaluation program” for evaluating the proper operability of the project based on the stored evaluation rule and the inputted diagnosis input. These programs are read into the main memory based on the execution instruction of a series of programs, and these programs are executed based on an operation start instruction. In this computer, the non-volatile memory, the main memory, the CPU, and the interface (for example, a display, a keyboard, communication, etc.) are connected to the bus lines so that they can communicate with each other. Further, in addition to the first embodiment, there is provided an “evaluation-dependent project information search program” for searching for another project evaluation result based on the project evaluation result.

<Flow of Processing>

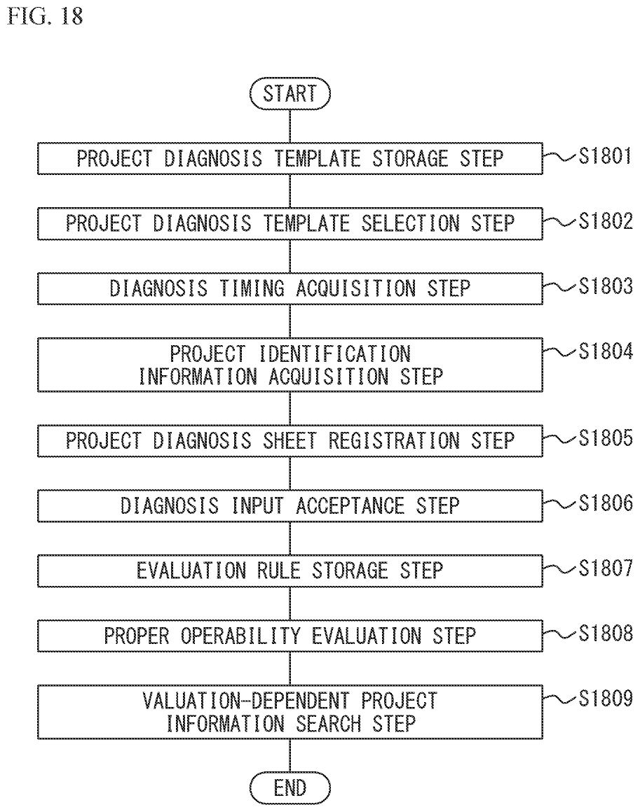

FIG. 18 is a diagram illustrating a flow of processing when the project diagnosis DB system according to the present embodiment is used. The flow of processing of the present embodiment is an operation method of the project diagnosis DB system which is a computer having a project diagnosis template storage step (S1801), a project diagnosis template selection step (S1802), a diagnosis timing acquisition step (S1803), a project identification information acquisition step (S1804), a project diagnosis sheet registration step (S1805), a diagnosis input acceptance step (S1806), an evaluation rule storage step (S1807), a proper operability evaluation step (S1808), and an evaluation-dependent project information search step (S1809). The steps other than the evaluation-dependent project information search step are the same as those in the first embodiment.

The “evaluation-dependent project information search step” is a step of searching for another project evaluation result based on the project evaluation result.

### Seventh Embodiment

In addition to the above-described embodiments, the present embodiment provides a project diagnosis DB system having a function of searching for the stored project diagnosis sheet.

<Functional Configuration>

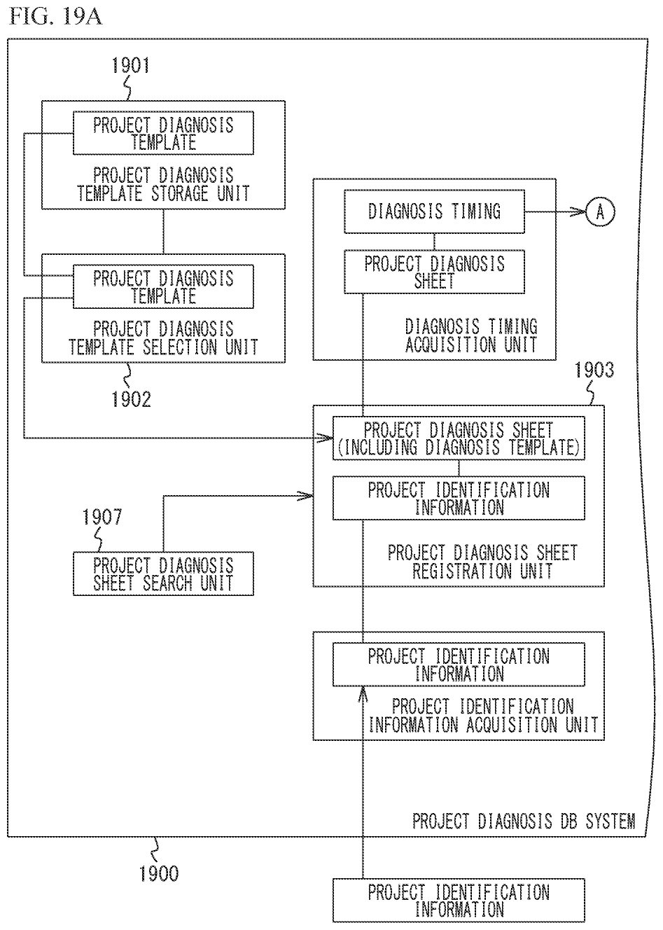

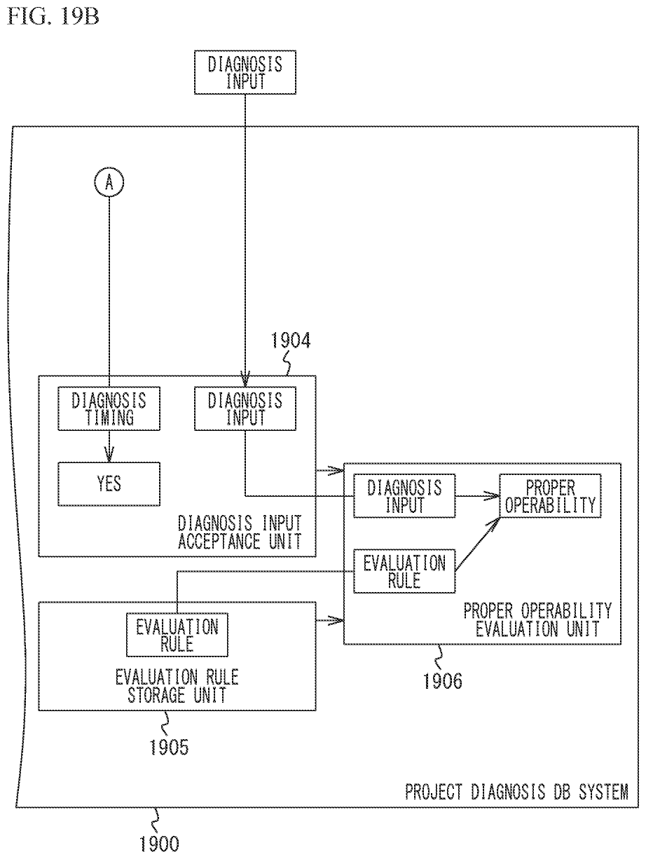

FIGS. 19A and 19B are diagrams illustrating the functional configuration according to the present embodiment. The project diagnosis DB system (1900) of the present embodiment has a project diagnosis template storage unit (1901), a project diagnosis template selection unit (1902), a project diagnosis sheet registration unit (1903), a diagnosis input acceptance unit (1904), an evaluation rule storage unit (1905), and a proper operability evaluation unit (1906) as in the first embodiment, and further has a project diagnosis sheet search unit (1907). The description will be made except for the functions already described.

The “project diagnosis sheet search unit” has a function of searching for the stored project diagnosis sheet. The project diagnosis sheet search unit may have a diagnostician key search unit for searching for the project diagnosis sheet using the project diagnostician identification information as a search key. In addition, the project diagnosis sheet search unit may have a diagnosis input key search unit for searching for the project diagnosis sheet using the diagnosis input as the search key.

<Hardware Configuration>

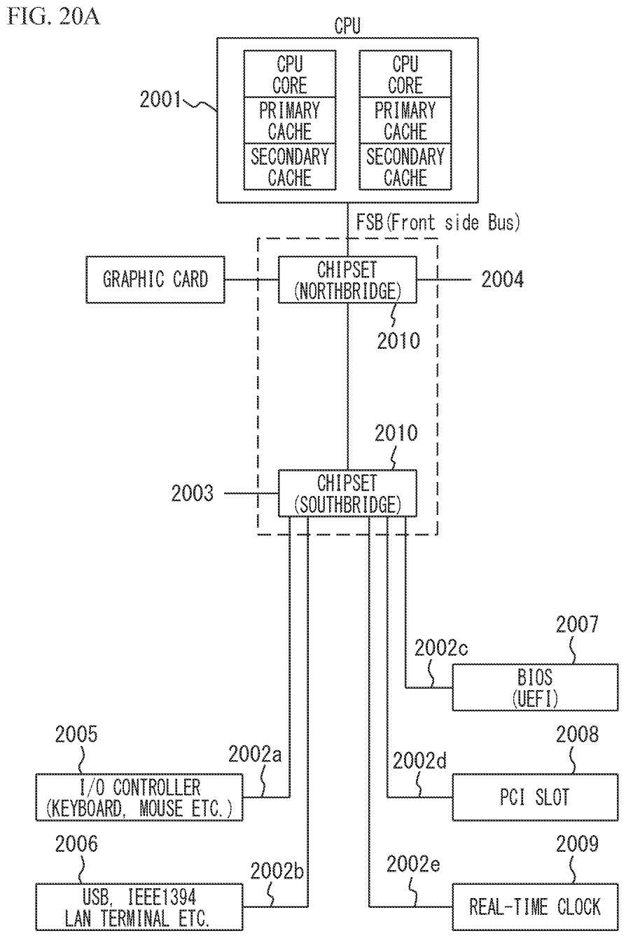

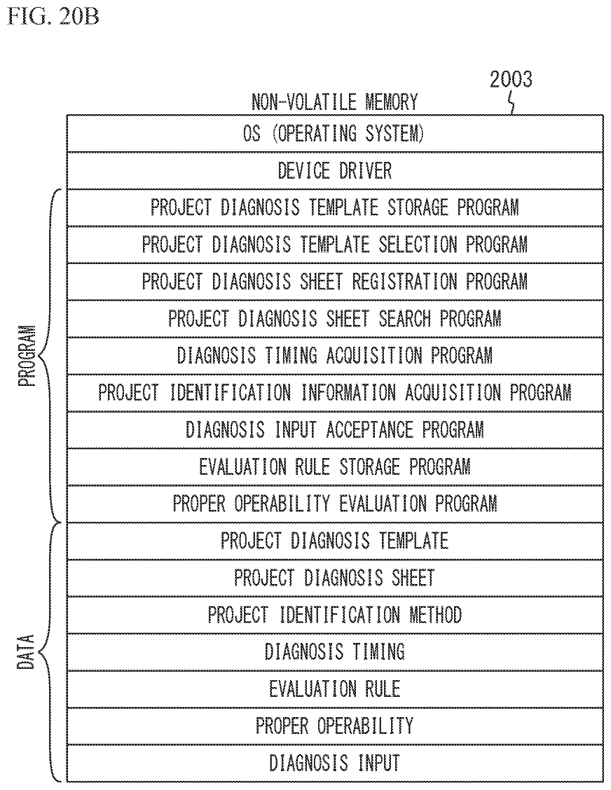

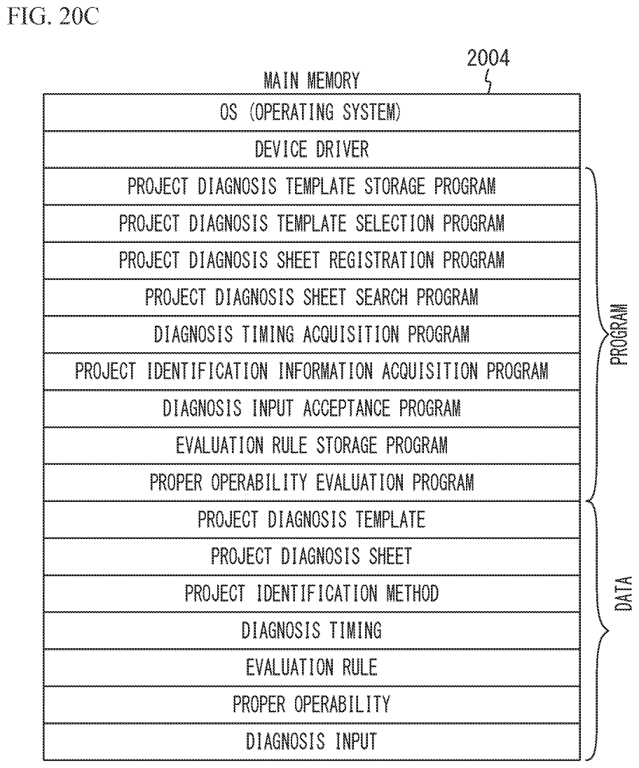

FIGS. 20A to 20C are diagrams illustrating a hardware configuration of the project diagnosis DB system according to the present embodiment. As illustrated in FIGS. 20A to 20C, the computer includes a chip set (2010), a CPU (2001), a non-volatile memory (2003), a main memory (2004), various buses (2002a to 2002e), a BIOS (2007), various interfaces (2005, 2006, 2008), a real-time clock (2009), and the like, which are configured on a motherboard. They work in conjunction with operating systems, device drivers and programs. Various programs and various data constituting the present embodiment are configured to execute various processes by efficiently utilizing these hardware resources.

Here, the “main memory” reads out programs for performing various processes in order to cause the “CPU” to execute the programs, and at the same time provides work areas for the programs. A plurality of addresses are allocated to each of the “main memory” and the “HDD”, and programs executed by the “CPU” can exchange data with each other and perform processing by specifying and accessing the addresses.

As illustrated in FIGS. 20A to 20C, the nonvolatile memory stores: a “project diagnosis template storage program” for storing a plurality of project diagnosis templates composed of diagnosis sentences in predetermined sentences for checking the proper operability of the project; a “project diagnosis template selection program” for allowing the user to select a project diagnosis template for checking the proper operability of the project being operated; a “diagnosis timing acquisition program” for acquiring a diagnosis timing which is a timing for diagnosing a project in order to associate it with the project diagnosis sheet to be described later; a “project identification information acquisition program” for acquiring project identification information, which is identification information of the project to be diagnosed, in order to associate the project identification information with the project diagnosis sheet to be described later, a “project diagnosis sheet registration program” for registering a selected diagnosis template as the project diagnosis sheet in association with information to be associated; a “diagnosis input acceptance program” for accepting a diagnosis input which is an input for judging whether the project is properly operated for each diagnosis item of the project diagnosis sheet; an “evaluation rule storing program” for storing evaluation rules to evaluate the accepted diagnosis input; and a “proper operability evaluation program” for evaluating the proper operability of the project based on the stored evaluation rule and the inputted diagnosis input. These programs are read into the main memory based on the execution instruction of a series of programs, and these programs are executed based on an operation start instruction. In this computer, the non-volatile memory, the main memory, the CPU, and the interface (for example, a display, a keyboard, communication, etc.) are connected to the bus lines so that they can communicate with each other. Further, in addition to the first embodiment, there is provided a “project diagnosis sheet search program” for searching for the stored project diagnosis sheet.

<Flow of Processing>

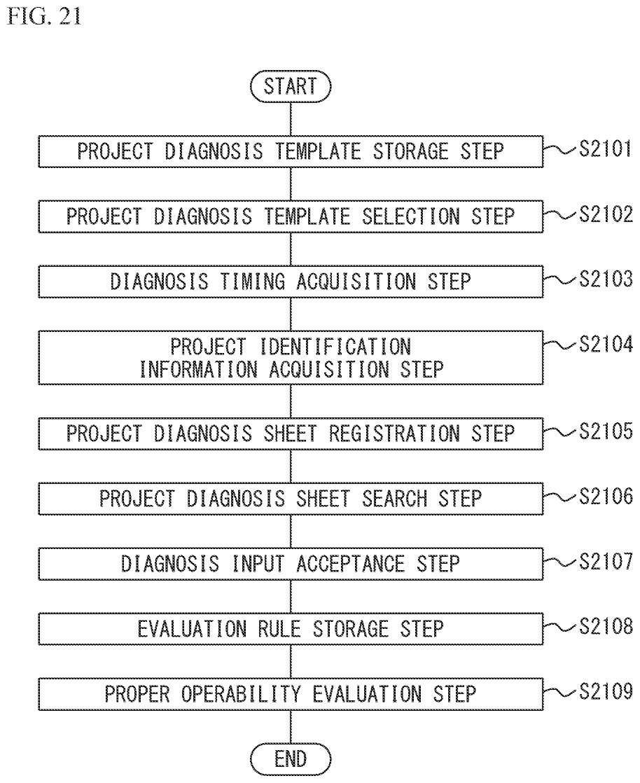

FIG. 21 is a diagram illustrating a flow of processing when the project diagnosis DB system according to the present embodiment is used. The flow of processing of the present embodiment is an operation method of the project diagnosis DB system which is a computer having a project diagnosis template storage step (S2101), a project diagnosis template selection step (S2102), a diagnosis timing acquisition step (S2103), a project identification information acquisition step (S2104), a project diagnosis sheet registration step (S2105), a project diagnosis sheet search step (S2106), a diagnosis input acceptance step (S2107), an evaluation rule storage step (S2108), and a proper operability evaluation step (S2109). The steps other than the project diagnosis sheet search step are the same as those in the first embodiment.

The “project diagnosis sheet search step” is a step of searching for the stored project diagnosis sheet.

### Eighth Embodiment

In addition to the above-described embodiments, the present embodiment provides a project diagnosis DB system having a function of comparing project diagnosis sheets with each other.

<Functional Configuration>

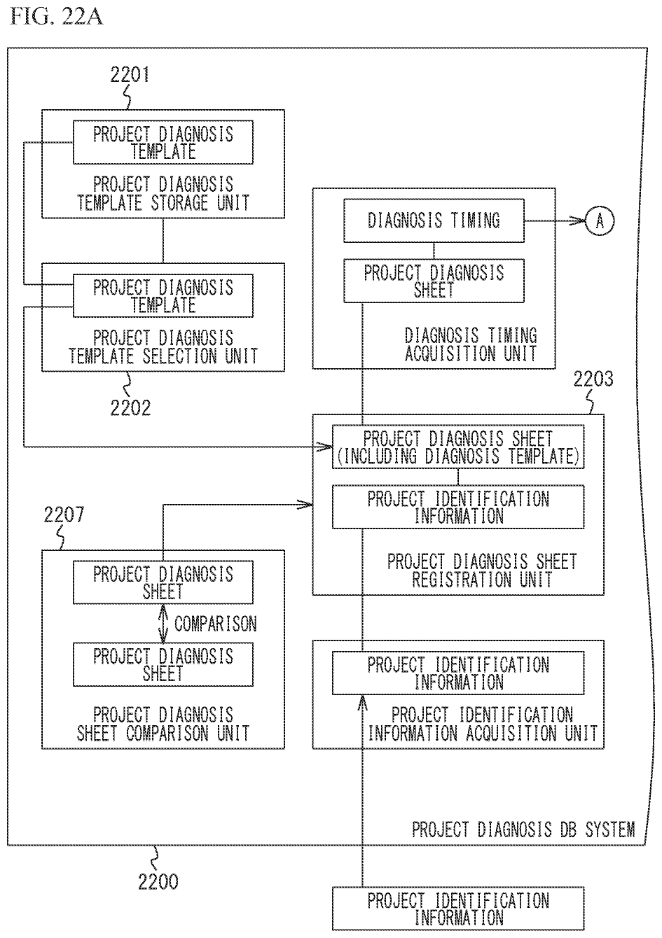

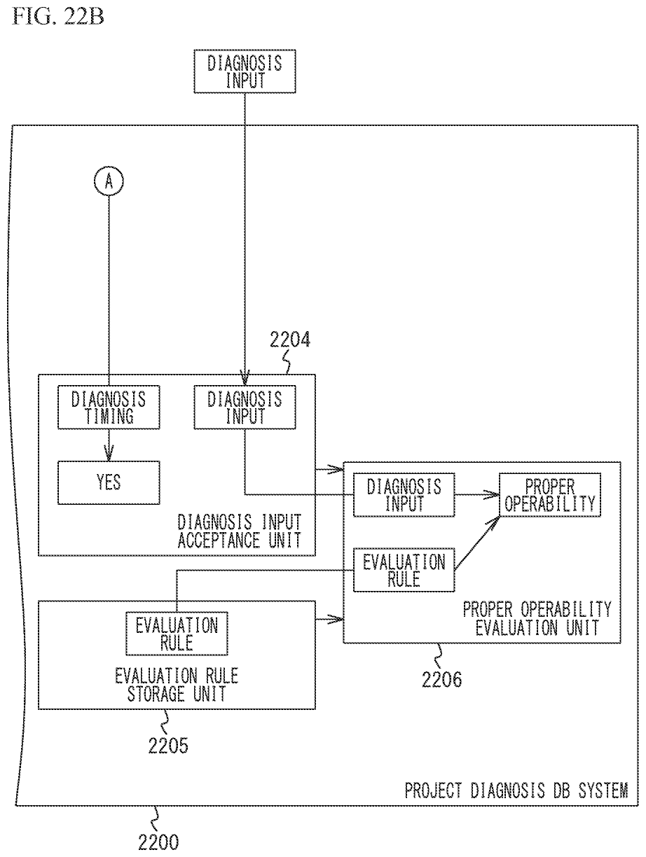

FIGS. 22A and 22B are diagrams illustrating the functional configuration according to the present embodiment. The project diagnosis DB system (2200) of the present embodiment has a project diagnosis template storage unit (2201), a project diagnosis template selection unit (2202), a project diagnosis sheet registration unit (2203), a diagnosis input acceptance unit (2204), an evaluation rule storage unit (2205), and a proper operability evaluation unit (2206) as in the first embodiment, and further has a project diagnosis sheet comparison unit (2207). The description will be made except for the functions already described.

The “project diagnosis sheet comparison unit” has a function of comparing the project diagnosis sheets with each other. The project diagnosis sheet comparison unit may have a project diagnosis sheet comparison unit with diagnosis input for comparing project diagnosis sheets having the diagnosis inputs with each other. For example, the project diagnosis sheet comparison unit may have an inter-diagnosticians project diagnosis sheet comparison unit for comparing different project diagnosis sheets having diagnosis inputs among a plurality of project diagnosticians. Further, the project diagnosis sheet comparison unit may have a common item project diagnosis sheet comparison unit for comparing the project diagnosis sheets with one or more of the same knowledge area, the same project management type, and the same diagnosis item among a plurality of diagnosis sheets having the diagnosis inputs. Further, the project diagnosis sheet comparison unit may have an average comparison output unit for outputting a comparison result using an average value of diagnosis inputs of a plurality of diagnosis sheets. Further, the project diagnosis sheet comparison unit may have a project diagnosis sheet comparer for calculating an average value for each industry, each type of industry, or each type of project based on accumulated diagnosis result information of a plurality of projects, and setting target values classified into a high level target value, a standard target value, and a low level target value.

<Hardware Configuration>

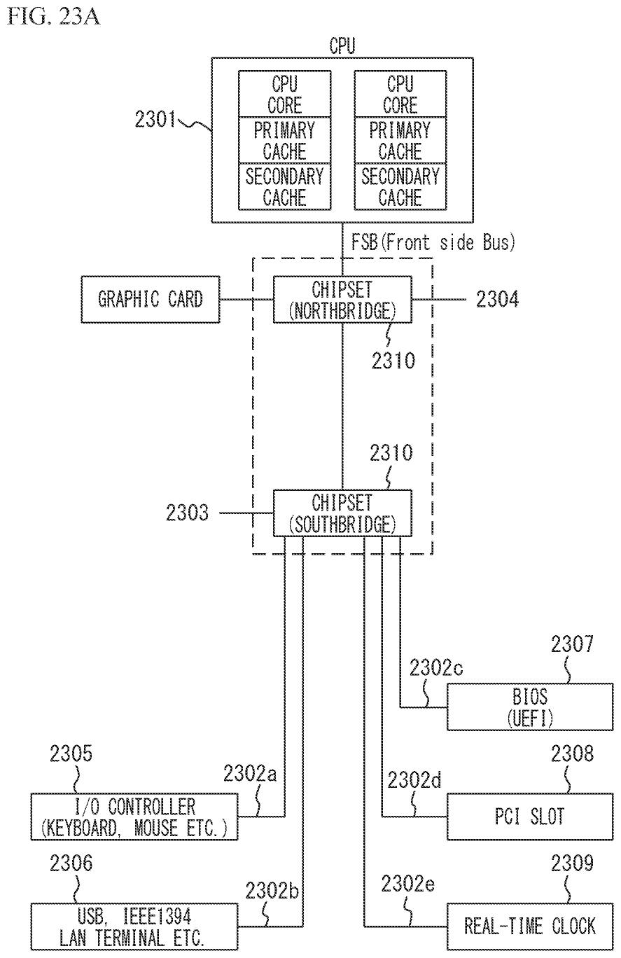

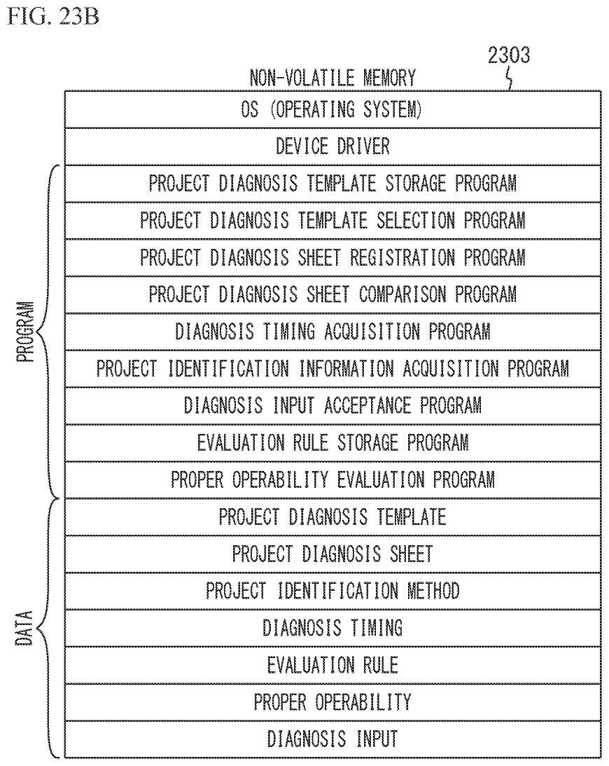

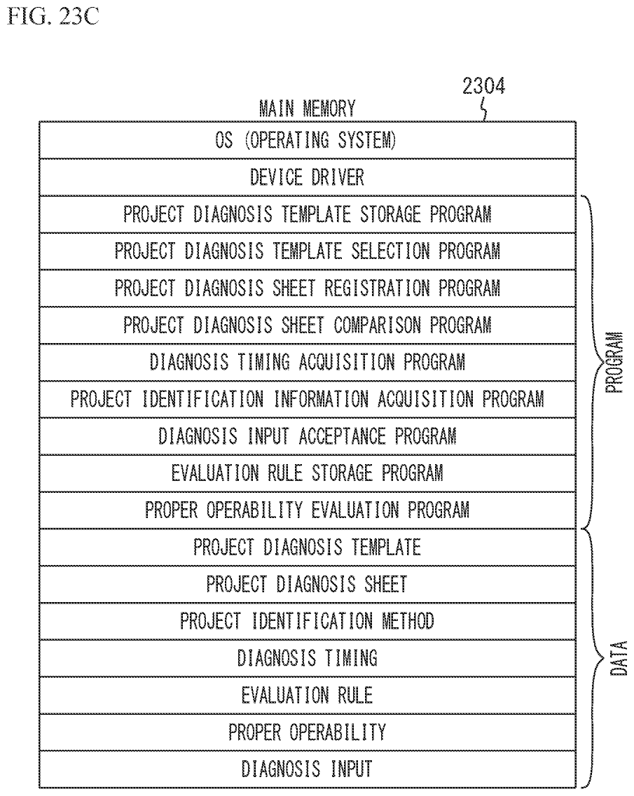

FIGS. 23A to 23C are diagrams illustrating a hardware configuration of the project diagnosis DB system according to the present embodiment. As illustrated in FIGS. 23A to 23C, the computer includes a chip set (2310), a CPU (2301), a non-volatile memory (2303), a main memory (2304), various buses (2302a to 2302e), a BIOS (2307), various interfaces (2305, 2306, 2308), a real-time clock (2309), and the like, which are configured on a motherboard. They work in conjunction with operating systems, device drivers and programs. Various programs and various data constituting the present embodiment are configured to execute various processes by efficiently utilizing these hardware resources.

Here, the “main memory” reads out programs for performing various processes in order to cause the “CPU” to execute the programs, and at the same time provides work areas for the programs. A plurality of addresses are allocated to each of the “main memory” and the “HDD”, and programs executed by the “CPU” can exchange data with each other and perform processing by specifying and accessing the addresses.

As illustrated in FIGS. 23A to 23C, the nonvolatile memory stores: a “project diagnosis template storage program” for storing a plurality of project diagnosis templates composed of diagnosis sentences in predetermined sentences for checking the proper operability of the project; a “project diagnosis template selection program” for allowing the user to select a project diagnosis template for checking the proper operability of the project being operated; a “diagnosis timing acquisition program” for acquiring a diagnosis timing which is a timing for diagnosing a project in order to associate it with the project diagnosis sheet to be described later; a “project identification information acquisition program” for acquiring project identification information, which is identification information of the project to be diagnosed, in order to associate the project identification information with the project diagnosis sheet to be described later, a “project diagnosis sheet registration program” for registering a selected diagnosis template as the project diagnosis sheet in association with information to be associated; a “diagnosis input acceptance program” for accepting a diagnosis input which is an input for judging whether the project is properly operated for each diagnosis item of the project diagnosis sheet; an “evaluation rule storing program” for storing evaluation rules to evaluate the accepted diagnosis input; and a “proper operability evaluation program” for evaluating the proper operability of the project based on the stored evaluation rule and the inputted diagnosis input. These programs are read into the main memory based on the execution instruction of a series of programs, and these programs are executed based on an operation start instruction. In this computer, the non-volatile memory, the main memory, the CPU, and the interface (for example, a display, a keyboard, communication, etc.) are connected to the bus lines so that they can communicate with each other. Further, in addition to the first embodiment, there is provided a “project diagnosis sheet comparison program” for comparing the project diagnosis sheets with each other.

<Flow of Processing>

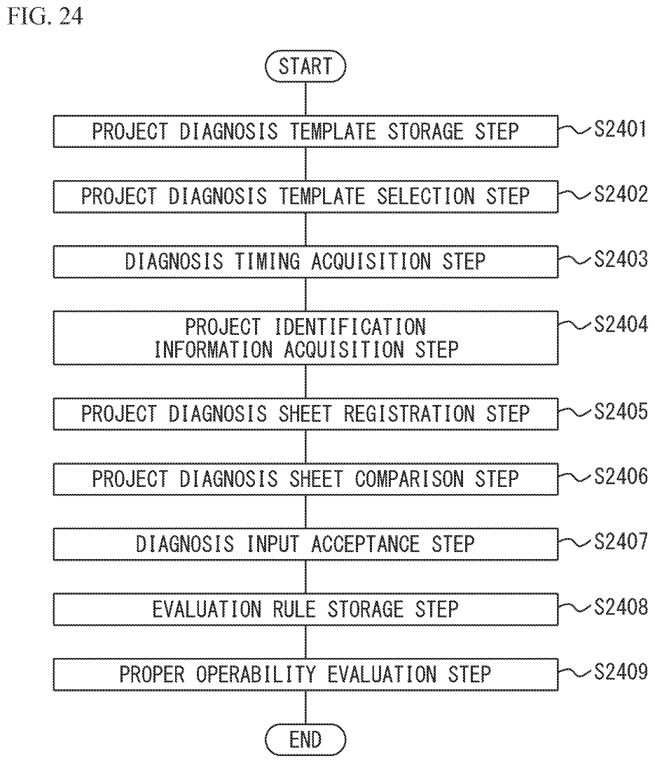

FIG. 24 is a diagram illustrating a flow of processing when the project diagnosis DB system according to the present embodiment is used. The flow of processing of the present embodiment is an operation method of the project diagnosis DB system which is a computer having a project diagnosis template storage step (S2401), a project diagnosis template selection step (S2402), a diagnosis timing acquisition step (S2403), a project identification information acquisition step (S2404), a project diagnosis sheet registration step (S2405), a project diagnosis sheet comparison step (S2406), a diagnosis input acceptance step (S2407), an evaluation rule storage step (S2408), and a proper operability evaluation step (S2409). The steps other than the project diagnosis sheet comparison step are the same as those in the first embodiment.

The “project diagnosis sheet comparison step” is a step of comparing the project diagnosis sheets with each other.

### Ninth Embodiment

In addition to the above-described embodiments, the present embodiment provides a project diagnosis DB system having a function of acquiring an input status of a diagnosis input and a function for outputting the acquired diagnosis input status.

<Functional Configuration>

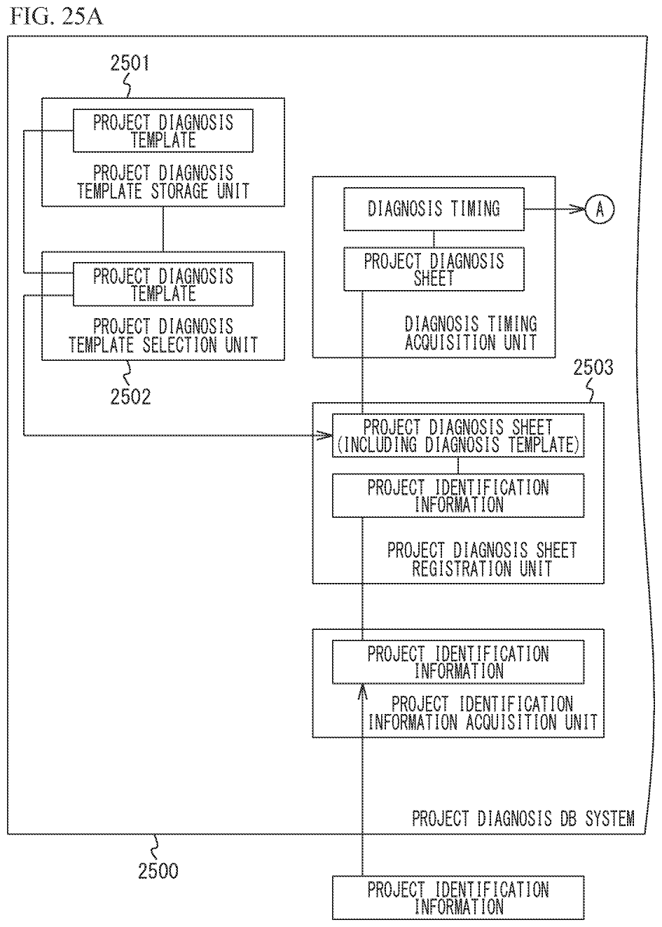

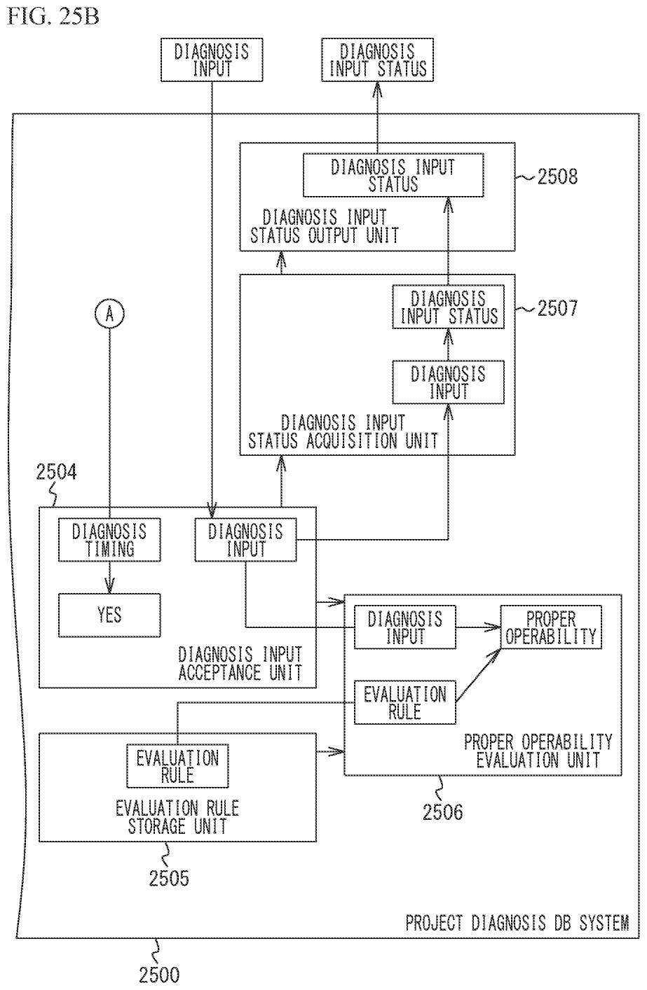

FIGS. 25A and 25B are diagrams illustrating the functional configuration according to the present embodiment. The project diagnosis DB system (2500) of the present embodiment has a project diagnosis template storage unit (2501), a project diagnosis template selection unit (2502), a project diagnosis sheet registration unit (2503), a diagnosis input acceptance unit (2504), an evaluation rule storage unit (2505), and a proper operability evaluation unit (2506) as in the first embodiment, and further has a diagnosis input status acquisition unit (2507) and a diagnosis input status output unit (2508). The description will be made except for the functions already described.

The “diagnosis input status acquisition unit” has a function of acquiring an input status of a diagnosis input.

The “diagnosis input status output unit” has a function of outputting the acquired diagnosis input status.

<Hardware Configuration>

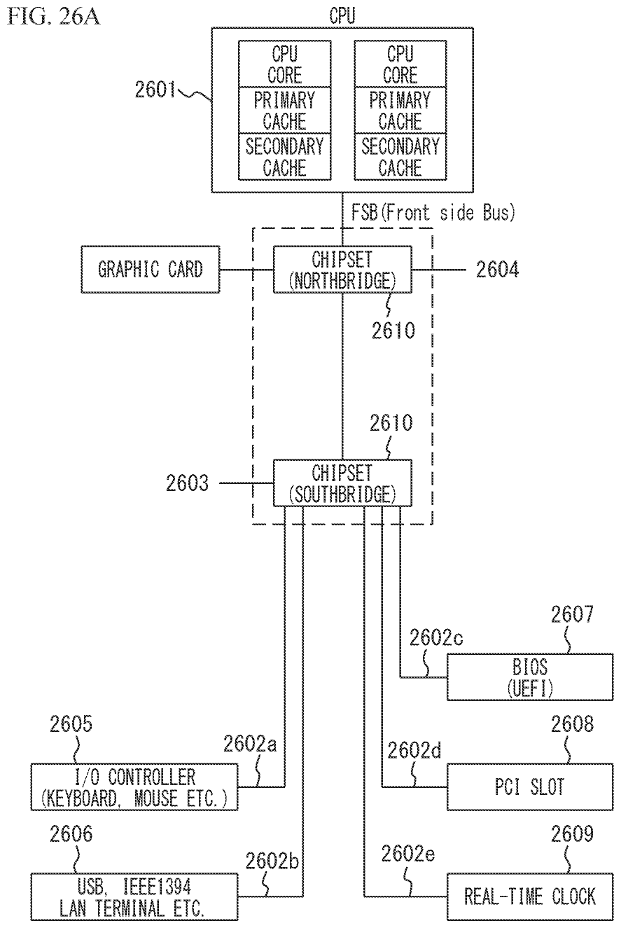

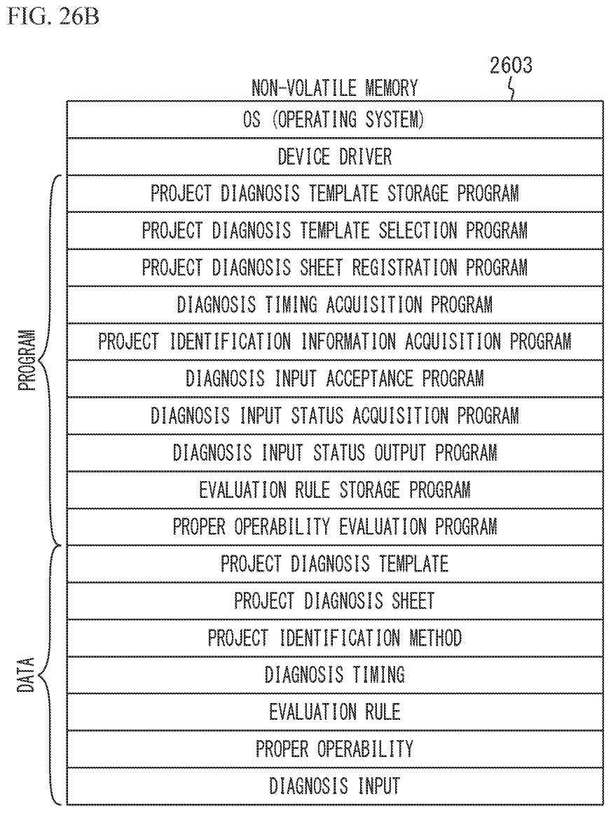

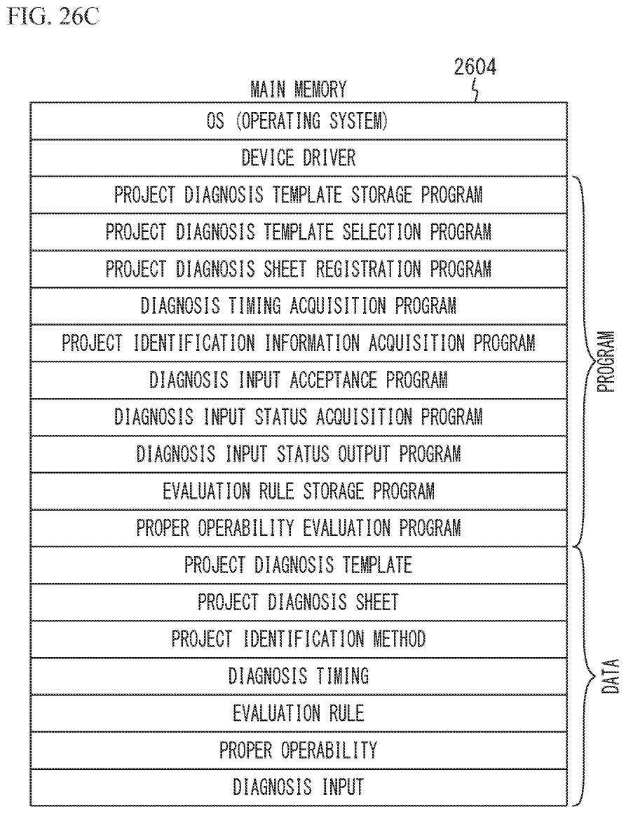

FIGS. 26 to 26C are diagrams illustrating a hardware configuration of the project diagnosis DB system according to the present embodiment. As illustrated in FIGS. 26 to 26C, the computer includes a chip set (2610), a CPU (2601), a non-volatile memory (2603), a main memory (2604), various buses (2602a to 2602e), a BIOS (2607), various interfaces (2605, 2606, 2608), a real-time clock (2609), and the like, which are configured on a motherboard. They work in conjunction with operating systems, device drivers and programs. Various programs and various data constituting the present embodiment are configured to execute various processes by efficiently utilizing these hardware resources.

Here, the “main memory” reads out programs for performing various processes in order to cause the “CPU” to execute the programs, and at the same time provides work areas for the programs. A plurality of addresses are allocated to each of the “main memory” and the “HDD”, and programs executed by the “CPU” can exchange data with each other and perform processing by specifying and accessing the addresses.

As illustrated in FIGS. 26 to 26C, the nonvolatile memory stores: a “project diagnosis template storage program” for storing a plurality of project diagnosis templates composed of diagnosis sentences in predetermined sentences for checking the proper operability of the project; a “project diagnosis template selection program” for allowing the user to select a project diagnosis template for checking the proper operability of the project being operated; a “diagnosis timing acquisition program” for acquiring a diagnosis timing which is a timing for diagnosing a project in order to associate it with the project diagnosis sheet to be described later; a “project identification information acquisition program” for acquiring project identification information, which is identification information of the project to be diagnosed, in order to associate the project identification information with the project diagnosis sheet to be described later, a “project diagnosis sheet registration program” for registering a selected diagnosis template as the project diagnosis sheet in association with information to be associated; a “diagnosis input acceptance program” for accepting a diagnosis input which is an input for judging whether the project is properly operated for each diagnosis item of the project diagnosis sheet; an “evaluation rule storing program” for storing evaluation rules to evaluate the accepted diagnosis input; and a “proper operability evaluation program” for evaluating the proper operability of the project based on the stored evaluation rule and the inputted diagnosis input. These programs are read into the main memory based on the execution instruction of a series of programs, and these programs are executed based on an operation start instruction. In this computer, the non-volatile memory, the main memory, the CPU, and the interface (for example, a display, a keyboard, communication, etc.) are connected to the bus lines so that they can communicate with each other. Further, in addition to the first embodiment, there are provided a “diagnosis input status acquisition program” for acquiring the input status of the diagnosis input and a “diagnosis input status output program” for outputting the acquired diagnosis input status.

<Flow of Processing>

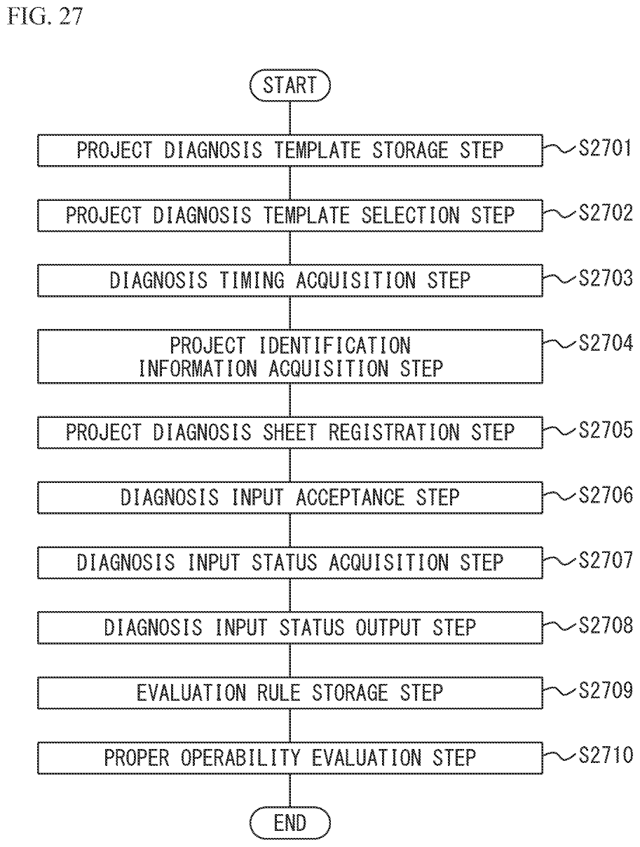

FIG. 27 is a diagram illustrating a flow of processing when the project diagnosis DB system according to the present embodiment is used. The flow of processing of the present embodiment is an operation method of the project diagnosis DB system which is a computer having a project diagnosis template storage step (S2701), a project diagnosis template selection step (S2702), a diagnosis timing acquisition step (S2703), a project identification information acquisition step (S2704), a project diagnosis sheet registration step (S2705), a diagnosis input acceptance step (S2706), a diagnosis input status acquisition step (S2707), a diagnosis input status output step (S2708), an evaluation rule storage step (S2709), and a proper operability evaluation step (S2710). The steps other than the diagnosis input status acquisition step and the diagnosis input status output step are the same as those in the first embodiment.

The “diagnosis input status acquisition step” is a step of acquiring the input status of the diagnosis input.

The “diagnosis input status output step” is a step of outputting the acquired diagnosis input status.

### Tenth Embodiment

In addition to the above-described embodiments, the present embodiment provides a project diagnosis DB system having a function of searching for a diagnosis template stored in a diagnosis template storage unit.

<Functional Configuration>

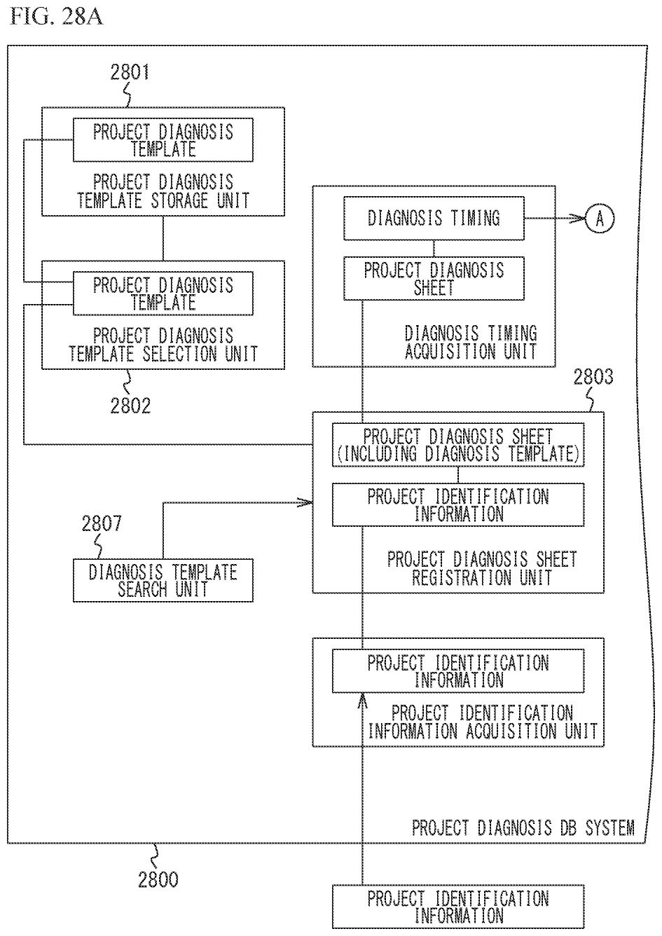

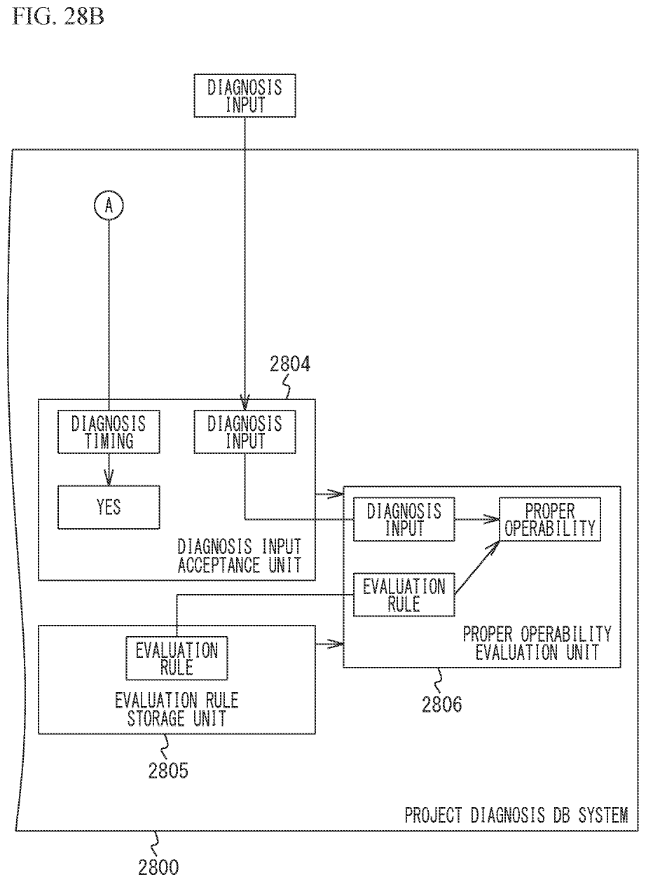

FIGS. 28A and 28B are diagrams illustrating the functional configuration according to the present embodiment. The project diagnosis DB system (2800) of the present embodiment has a project diagnosis template storage unit (2801), a project diagnosis template selection unit (2802), a project diagnosis sheet registration unit (2803), a diagnosis input acceptance unit (2804), an evaluation rule storage unit (2805), and a proper operability evaluation unit (2806) as in the first embodiment, and further has a diagnosis template search unit (2807). The description will be made except for the functions already described.

The “diagnosis template search unit” has a function of searching for the diagnosis template stored in the diagnosis template storage unit.

<Hardware Configuration>

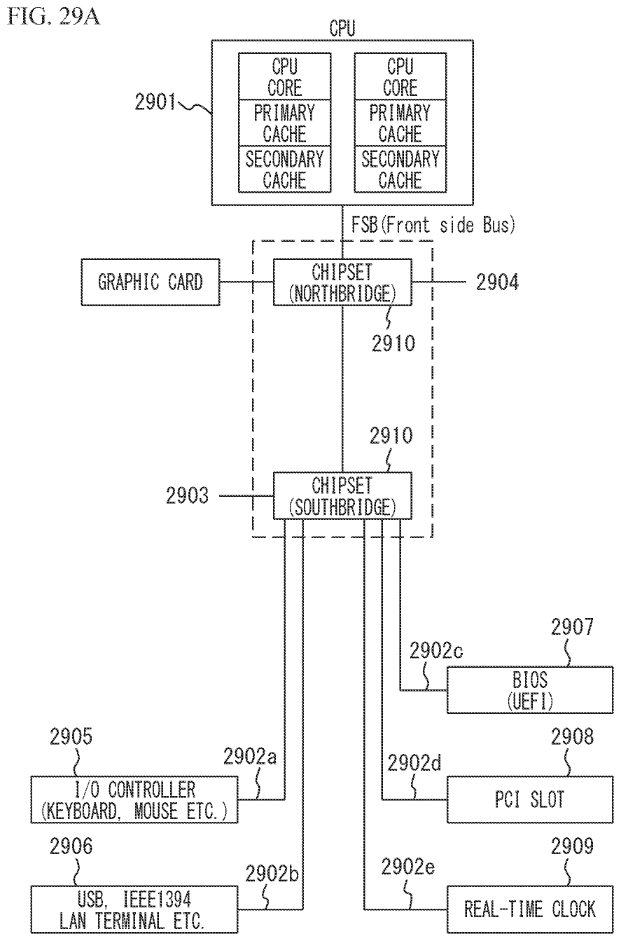

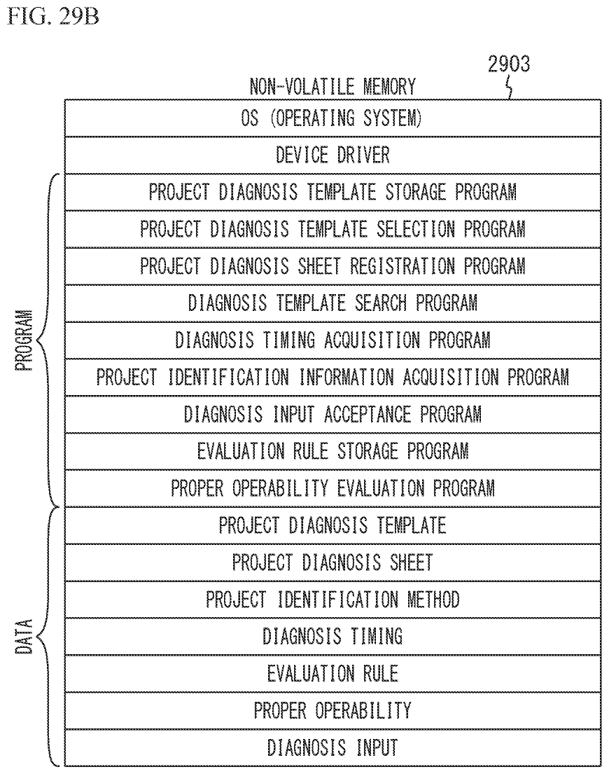

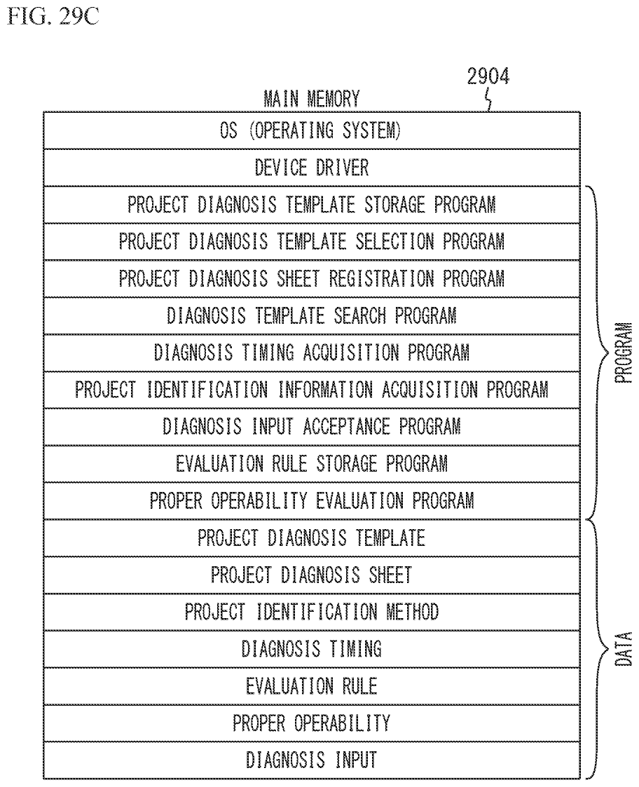

FIGS. 29A to 29C are diagrams illustrating a hardware configuration of the project diagnosis DB system according to the present embodiment. As illustrated in FIG. 29, the computer includes a chip set (2910), a CPU (2901), a non-volatile memory (2903), a main memory (2904), various buses (2902a to 2902e), a BIOS (2907), various interfaces (2905, 2906, 2908), a real-time clock (2909), and the like, which are configured on a motherboard. They work in conjunction with operating systems, device drivers and programs. Various programs and various data constituting the present embodiment are configured to execute various processes by efficiently utilizing these hardware resources.

Here, the “main memory” reads out programs for performing various processes in order to cause the “CPU” to execute the programs, and at the same time provides work areas for the programs. A plurality of addresses are allocated to each of the “main memory” and the “HDD”, and programs executed by the “CPU” can exchange data with each other and perform processing by specifying and accessing the addresses.

As illustrated in FIG. 29, the nonvolatile memory stores: a “project diagnosis template storage program” for storing a plurality of project diagnosis templates composed of diagnosis sentences in predetermined sentences for checking the proper operability of the project; a “project diagnosis template selection program” for allowing the user to select a project diagnosis template for checking the proper operability of the project being operated; a “diagnosis timing acquisition program” for acquiring a diagnosis timing which is a timing for diagnosing a project in order to associate it with the project diagnosis sheet to be described later; a “project identification information acquisition program” for acquiring project identification information, which is identification information of the project to be diagnosed, in order to associate the project identification information with the project diagnosis sheet to be described later, a “project diagnosis sheet registration program” for registering a selected diagnosis template as the project diagnosis sheet in association with information to be associated; a “diagnosis input acceptance program” for accepting a diagnosis input which is an input for judging whether the project is properly operated for each diagnosis item of the project diagnosis sheet; an “evaluation rule storing program” for storing evaluation rules to evaluate the accepted diagnosis input; and a “proper operability evaluation program” for evaluating the proper operability of the project based on the stored evaluation rule and the inputted diagnosis input. These programs are read into the main memory based on the execution instruction of a series of programs, and these programs are executed based on an operation start instruction. In this computer, the non-volatile memory, the main memory, the CPU, and the interface (for example, a display, a keyboard, communication, etc.) are connected to the bus lines so that they can communicate with each other. Further, in addition to the first embodiment, there is provided a “diagnosis template search program” for searching for the diagnosis template stored in the diagnosis template storage unit.

<Flow of Processing>

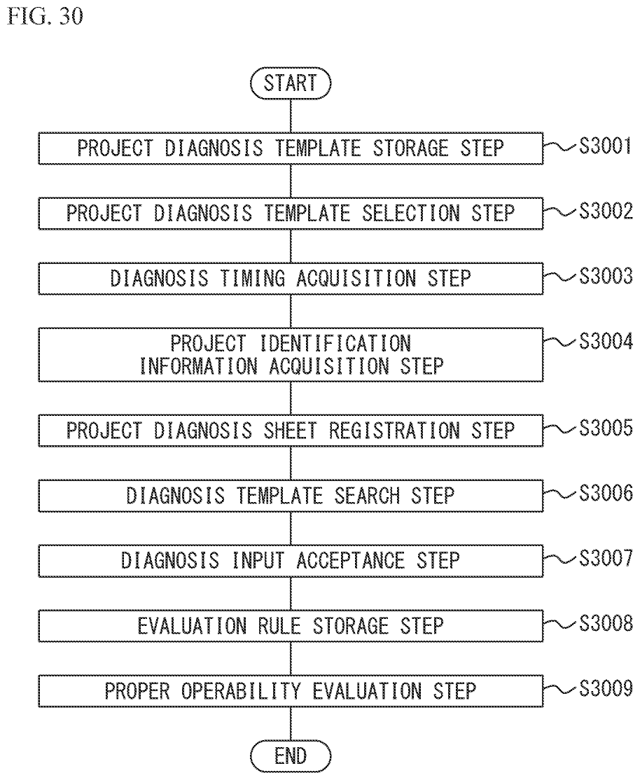

FIG. 30 is a diagram illustrating a flow of processing when the project diagnosis DB system according to the present embodiment is used. The flow of processing of the present embodiment is an operation method of the project diagnosis DB system which is a computer having a project diagnosis template storage step (S3001), a project diagnosis template selection step (S3002), a diagnosis timing acquisition step (S3003), a project identification information acquisition step (S3004), a project diagnosis sheet registration step (S3005), a diagnosis template search step (S3006), a diagnosis input acceptance step (S3007), an evaluation rule storage step (S3008), and a proper operability evaluation step (S3009). The steps other than the diagnosis template search step are the same as those in the first embodiment.

The “diagnosis template search step” is a step of searching for the diagnosis template stored in the diagnosis template storage unit.

### Eleventh Embodiment

In addition to the above-described embodiments, the present embodiment provides a project diagnosis DB system having a function of managing a project diagnosis template.

<Functional Configuration>

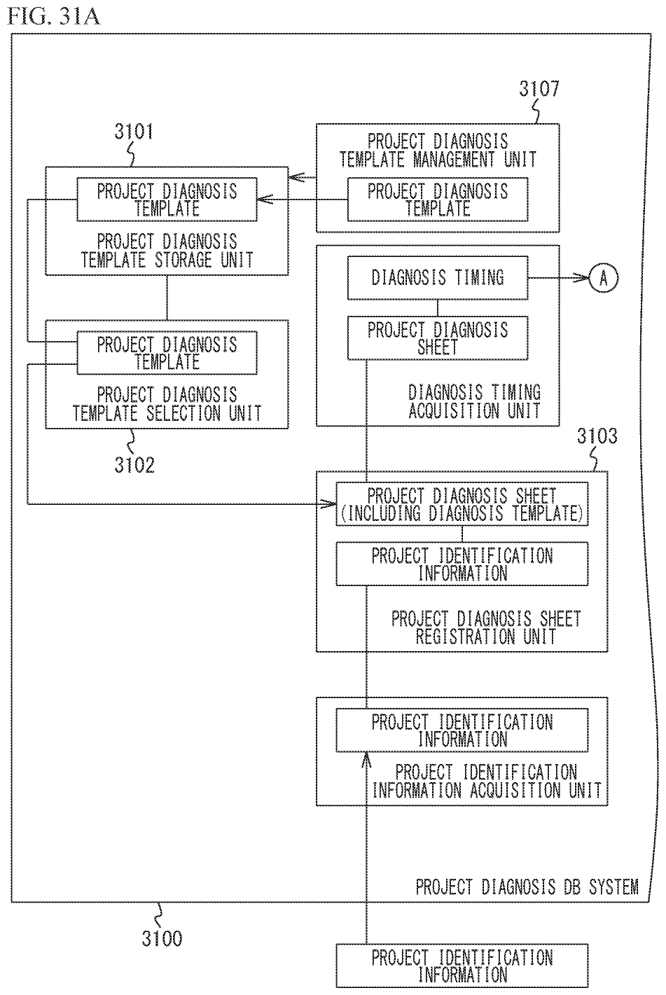

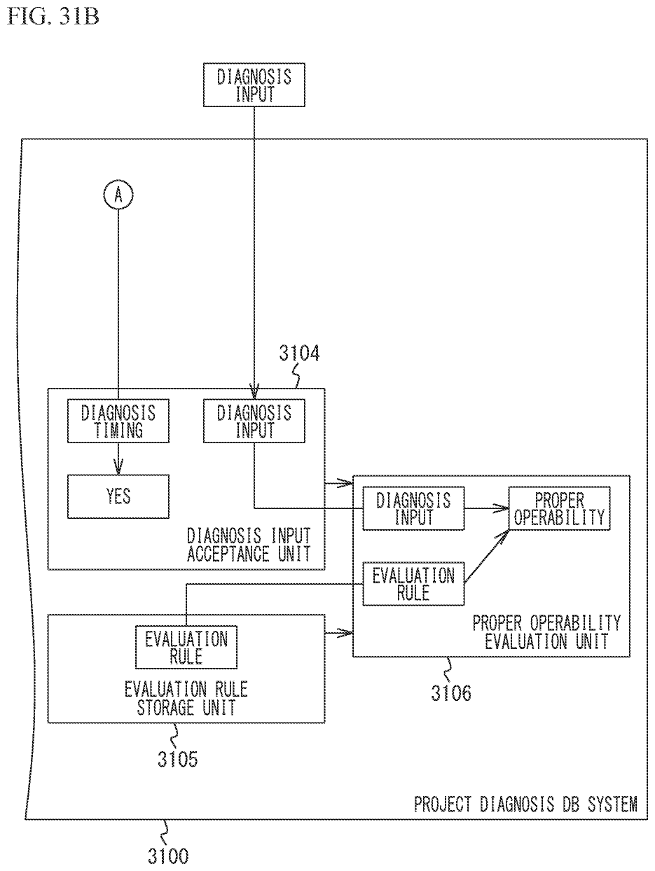

FIGS. 31A and 31B are diagrams illustrating the functional configuration according to the present embodiment. The project diagnosis DB system (3100) of the present embodiment has a project diagnosis template storage unit (3101), a project diagnosis template selection unit (3102), a project diagnosis sheet registration unit (3103), a diagnosis input acceptance unit (3104), an evaluation rule storage unit (3105), and a proper operability evaluation unit (3106) as in the first embodiment, and further has a project diagnosis template management unit (3107). The description will be made except for the functions already described.

The “project diagnosis template management unit” has a function of managing the project diagnosis template.

<Hardware Configuration>

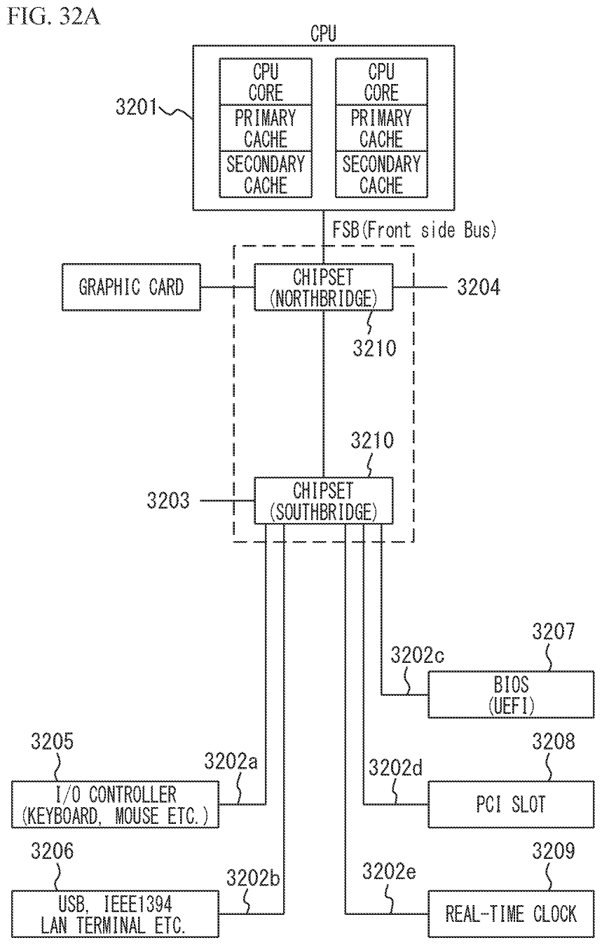

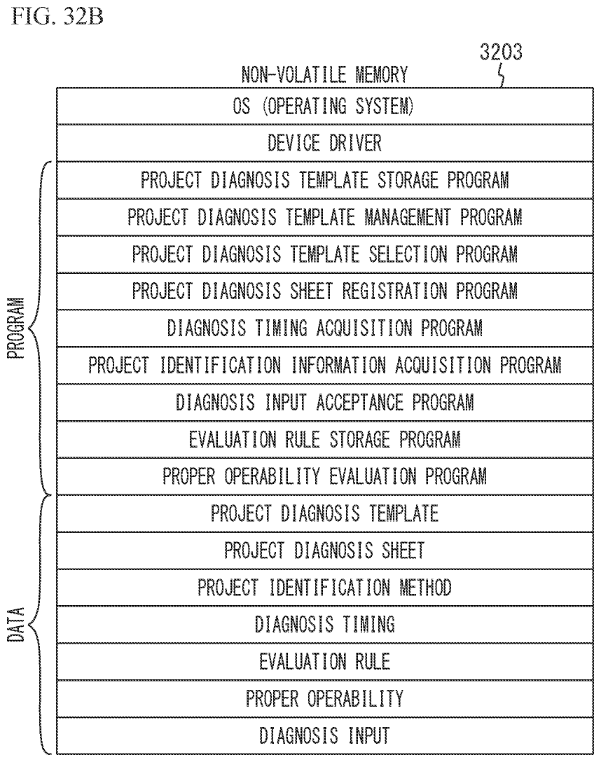

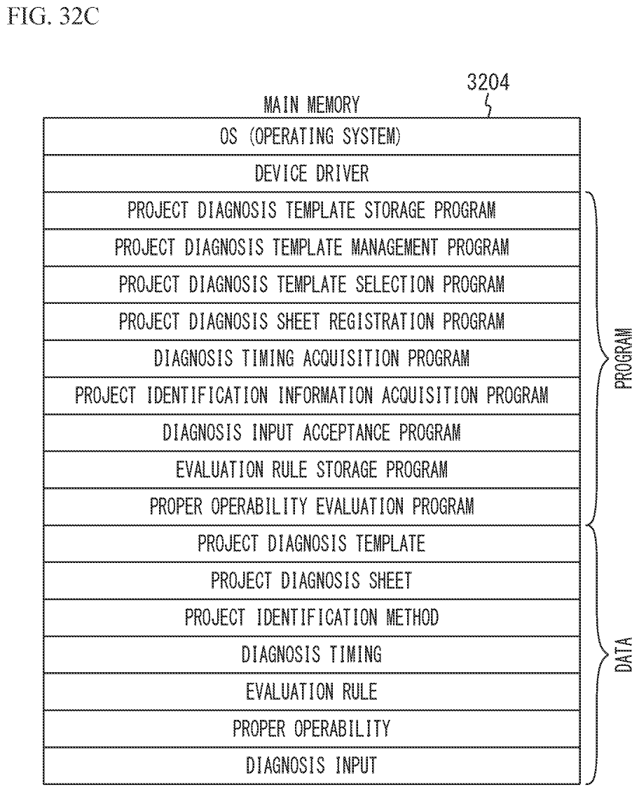

FIGS. 32A to 32C are diagrams illustrating a hardware configuration of the project diagnosis DB system according to the present embodiment. As illustrated in FIG. 32, the computer includes a chip set (3210), a CPU (3201), a non-volatile memory (3203), a main memory (3204), various buses (3202a to 3202e), a BIOS (3207), various interfaces (3205, 3206, 3208), a real-time clock (3209), and the like, which are configured on a motherboard. They work in conjunction with operating systems, device drivers and programs. Various programs and various data constituting the present embodiment are configured to execute various processes by efficiently utilizing these hardware resources.

Here, the “main memory” reads out programs for performing various processes in order to cause the “CPU” to execute the programs, and at the same time provides work areas for the programs. A plurality of addresses are allocated to each of the “main memory” and the “HDD”, and programs executed by the “CPU” can exchange data with each other and perform processing by specifying and accessing the addresses.

As illustrated in FIGS. 32A to 32C, the nonvolatile memory stores: a “project diagnosis template storage program” for storing a plurality of project diagnosis templates composed of diagnosis sentences in predetermined sentences for checking the proper operability of the project; a “project diagnosis template selection program” for allowing the user to select a project diagnosis template for checking the proper operability of the project being operated; a “diagnosis timing acquisition program” for acquiring a diagnosis timing which is a timing for diagnosing a project in order to associate it with the project diagnosis sheet to be described later; a “project identification information acquisition program” for acquiring project identification information, which is identification information of the project to be diagnosed, in order to associate the project identification information with the project diagnosis sheet to be described later, a “project diagnosis sheet registration program” for registering a selected diagnosis template as the project diagnosis sheet in association with information to be associated; a “diagnosis input acceptance program” for accepting a diagnosis input which is an input for judging whether the project is properly operated for each diagnosis item of the project diagnosis sheet; an “evaluation rule storing program” for storing evaluation rules to evaluate the accepted diagnosis input; and a “proper operability evaluation program” for evaluating the proper operability of the project based on the stored evaluation rule and the inputted diagnosis input. These programs are read into the main memory based on the execution instruction of a series of programs, and these programs are executed based on an operation start instruction. In this computer, the non-volatile memory, the main memory, the CPU, and the interface (for example, a display, a keyboard, communication, etc.) are connected to the bus lines so that they can communicate with each other. Further, in addition to the first embodiment, there is provided a “project diagnosis template management program” for managing the project diagnosis template.

<Flow of Processing>

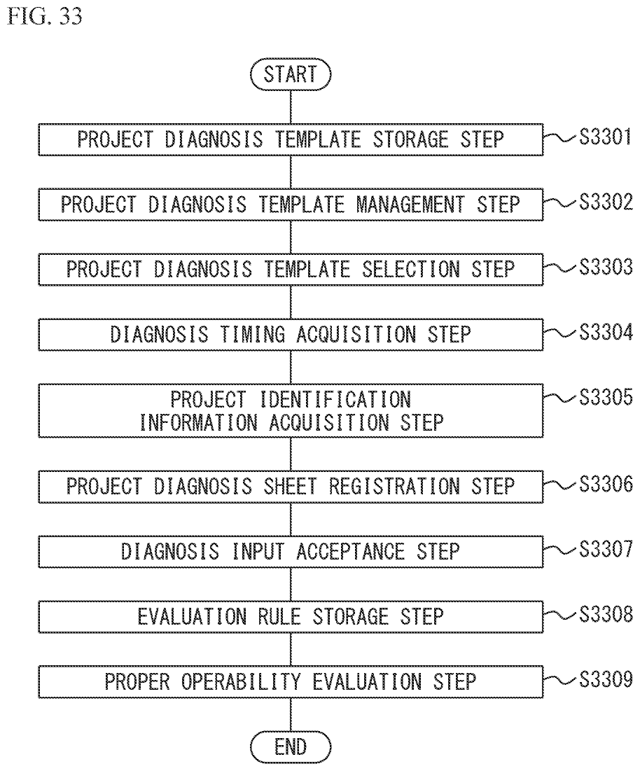

FIG. 33 is a diagram illustrating a flow of processing when the project diagnosis DB system according to the present embodiment is used. The flow of processing of the present embodiment is an operation method of the project diagnosis DB system which is a computer having a project diagnosis template storage step (S3301), a project diagnosis template management step (S3302), a project diagnosis template selection step (S3303), a diagnosis timing acquisition step (S3304), a project identification information acquisition step (S3305), a project diagnosis sheet registration step (S3306), a diagnosis input acceptance step (S3307), an evaluation rule storage step (S3308), and a proper operability evaluation step (S3309). The steps other than the project diagnosis template management step are the same as those in the first embodiment.

The “project diagnosis template management step” is a step of managing the project diagnosis template. This management allows the user to download, modify and upload data of the project diagnosis template from the screen. The user can also remotely re-install the project diagnosis template, or remotely install additional project diagnosis template.

### Twelfth Embodiment

The present embodiment provides a project diagnosis DB system having an automatic diagnosis function in addition to the above-described embodiment.

The project diagnosis DB system of this embodiment further includes a functional unit that, after evaluating the proper operability of the project, automatically evaluates the proper operability of the project based on data input through a function of schedule management, problem management, risk management, change management, or quality management, and outputs an improvement status.

### <Example of Diagnosis Sentence of Project Diagnosis Template>

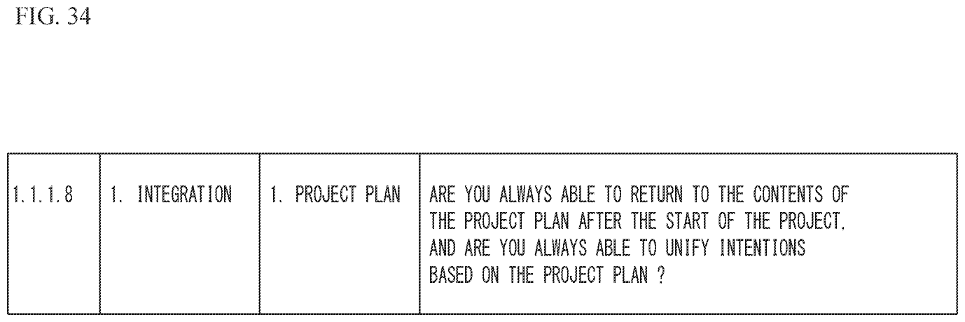

FIG. 34 illustrates a diagnosis sentence that prompts the user to answer whether the project plan is utilized for unifying the intention or consciousness after the start of the project. In FIG. 34, in a category “1. Integration” and a title “1. Project Plan”, a diagnosis sentence stating “Are you always able to return to the contents of the project plan after the start of the project, and are you always able to unify intentions based on the project plan ?” is described.

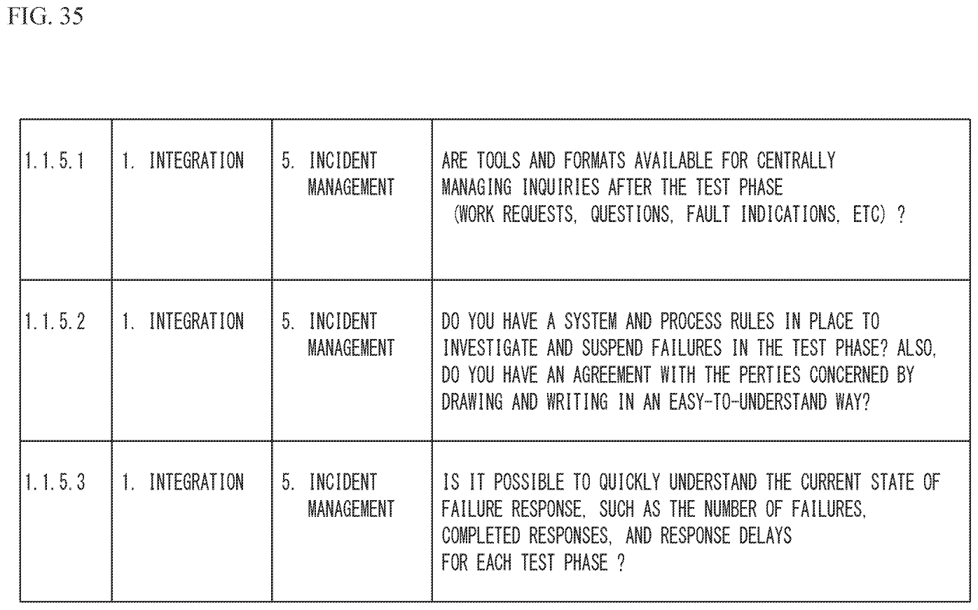

FIG. 35 illustrates a diagnosis sentence that prompts the user to answer whether incident management is utilized as a management indicator after the test phase. In FIG. 35, in the category “1. Integration” and a title “5. Incident Management”, a diagnosis sentence stating “Are tools and formats available for centrally managing inquiries after the test phase (work requests, questions, fault indications, etc.) ?” is described.

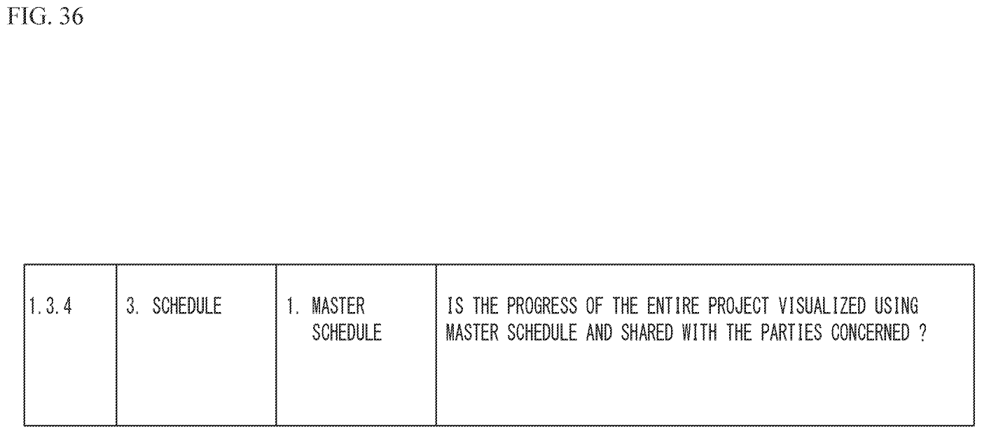

FIG. 36 illustrates a diagnosis sentence that prompts the user to answer whether a master schedule is applied to the progress management of the whole project. In FIG. 36, in a category “3. Schedule” and a title “1. master schedule”, a diagnosis sentence stating “Is the progress of the entire project visualized using master schedule and shared with the parties concerned ?” is described.

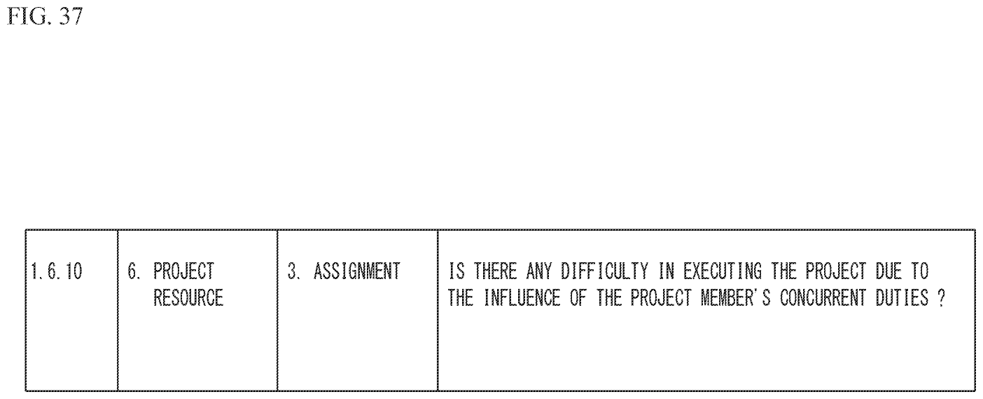

FIG. 37 illustrates a diagnosis sentence that prompts the user to answer a level of involvement or a degree of influence of a concurrent member who is engaged in a regular work and the project. In FIG. 37, in a category “6. Project Resources” and the title “3. Assignment”, a diagnosis sentence stating “Is there any difficulty in executing the project due to the influence of the project member's concurrent duties?” is described.

Further, the project diagnosis template may include a diagnosis sentence that prompts the user to answer whether information is shared with parties concerned, whether agreement is formed with the parties concerned, or whether intention is unified with the parties concerned. Specifically, it may be a diagnosis sentence stating “Is the content of the project plan explained to the main parties involved in the project and is agreement obtained ?” classified into the category “1. Integration” and the title “1. Project Plan”.

Further, the project diagnosis template may include a diagnosis sentence that prompts the user to answer whether a criterion for a problem to be immediately shared with a higher-level organization is clarified, whether quantitative management is performed, or whether a department and a plan corresponding to the problem are clarified. Specifically, it may be a diagnosis sentence stating “Is a criterion for sharing and communicating important problems to upper layer such as from a team to a project and from the project to a steering committee clear ?” classified into the category “1. Integration” and a title “2. Issue Management”.

Further, the project diagnosis template may include a diagnosis sentence that prompts the user to answer whether the parties concerned agree on a necessity of determining a baseline or a judgment criterion or taking a measure for change. Specifically, it may be a diagnosis sentence stating “Are a timing for determining a baseline, an approver, and an approval method clear ?” classified into the category “1. Integration” and a title “3. Change management”.

Further, the project diagnosis template may include a diagnosis sentence that prompts the user to answer whether a phase can be started after clarifying what is deliverables. Specifically, it may be a diagnosis sentence stating “Do you prepare a list of deliverables before a phase starts and understand a type, a number, a difficulty level, estimated man-hours, or the like of the deliverables to be prepared ?” classified into a category “2. Scope” and a title “1. Deliverables”.

In addition, the project diagnosis template may include a diagnosis sentence that prompts the user to answer whether misunderstanding between the parties concerned is reduced and a quality of an upstream process of the project is improved, by centrally managing requirements using a list. Specifically, it may be a diagnosis sentence stating “Do you prepare tools and formats for centrally managing user's requirements ?” classified into the category “2. Scope” and a title “2. Requirements”.

Further, the project diagnosis template may include a diagnosis sentence that prompts the user to answer whether a preparation rule of a work schedule or a progress rate setting is clarified. Specifically, it may be a diagnosis sentence stating “Is a standard or criterion for setting a progress rate clarified instead of leaving it to the subject ?” classified into a category “3. Schedule” and the title “2. WBS”.

Further, the project diagnosis template may include a diagnosis sentence that prompts the user to the user answer whether consistency between a master schedule and a work schedule or consistency between the deliverables and the work schedule is confirmed. Specifically, it may be a diagnosis sentence stating “Is WBS always consistent with the master schedule ?” classified into the category “3. Schedule” and a title “5. Work plan”.

Further, the project diagnosis template may include a diagnosis sentence that prompts the user to answer whether a person who reviews the deliverables is clarified, a review task is registered in the work schedule, or a progress status of a review is visualized, in quality assurance. Specifically, it may be a diagnosis sentence stating “Are deliverables to be reviewed and reviewers clarified before the phase starts ?” classified into a category “5. Quality” and a title “1. Quality Assurance”.

Further, the project diagnosis template may include a diagnosis sentence that prompts the user to answer whether a participation schedule of undecided members or validity of skills and man-hours is confirmed. Specifically, it may be a diagnosis sentence stating “If unassignable persons are included, is there a definite assignment schedule ?” classified into a category “6. Project resources” and a title “3. Assignment”.

In addition, the project diagnosis template may include a diagnosis sentence that prompts the user to answer whether a meeting is set in consideration of reporting to a higher level, a content of the meeting is reviewed according to a situation, or a planned meeting is appropriately managed. Specifically, it may be a diagnosis sentence stating “Is consideration taken so that reports from a lower level to a higher level can be made in order without leaving a number of days ?” classified into a category “7. Communication” and a title “1. Conference body”.

In addition, the project diagnosis template may include a diagnosis sentence that prompts the user to whether an appropriate number of risks is extracted or a project-specific measure is considered, in risk management. Specifically, it may be a diagnosis sentence stating “Can an appropriate number (about 10-50) of risks be extracted ?” classified into a category “8. Risks” and a title “2. Identification and analysis”.

What is claimed is:

1. A project diagnosis DB system that diagnoses whether a project is properly operated while the project is in progress and provides a database storing the results of diagnosis, comprising:
a project diagnosis template storage configured to storage a plurality of project diagnosis templates each provided with a plurality of diagnosis items composed of diagnosis sentences in predetermined sentences for checking the proper operability of the project;
a project diagnosis template selector configured to allow a user to select a project diagnosis template for checking the proper operability of the project being operated; and
a project diagnosis sheet register configured to register the selected project diagnosis template as a project diagnosis sheet in association with information to be associated.

2. The project diagnosis DB system according to claim 1, further comprising
a project diagnosis sheet comparer configured to calculate an average value for each industry, each type of industry, or each type of project based on accumulated diagnosis result information of a plurality of projects, and set target values classified into a high level target value, a standard target value, and a low level target value.

3. The project diagnosis DB system according to claim 1, further comprising
a functional unit configured to, after evaluating the proper operability of the project, automatically evaluate the proper operability of the project based on data input through a function of schedule management, problem management, risk management, change management, or quality management, and output an improvement status.

4. The project diagnosis DB system according to claim 1, wherein
the project diagnosis template includes at least a diagnosis sentence that prompts the user to answer whether a project plan is utilized for unifying intention or consciousness after the start of the project.

5. The project diagnosis DB system according to claim 1, wherein
the project diagnosis template includes at least a diagnosis sentence that prompts the user to answer whether incident management is utilized as a management indicator after a test phase.

6. The project diagnosis DB system according to claim 1, wherein
the project diagnosis template includes at least a diagnosis sentence that prompts the user to answer whether a master schedule is applied to progress management of the whole project.

7. The project diagnosis DB system according to claim 1, wherein
the project diagnosis template includes at least a diagnosis sentence that prompts the user to answer a level of involvement or a degree of influence of a concurrent member who is engaged in a regular work and the project.

8. The project diagnosis DB system according to claim 1, wherein
the project diagnosis template includes at least a diagnosis sentence that prompts the user to answer whether information is shared with parties concerned, whether agreement is formed with the parties concerned, or whether intention is unified with the parties concerned.

9. The project diagnosis DB system according to claim 1, wherein
the project diagnosis template includes at least a diagnosis sentence that prompts the user to answer whether a criterion for a problem to be immediately shared with a higher-level organization is clarified, whether quantitative management is performed, or whether a department and a plan corresponding to a problem are clarified.

10. The project diagnosis DB system according to claim 1, wherein
the project diagnosis template includes at least a diagnosis sentence that prompts the user to answer whether parties concerned agree on a necessity of determining a baseline or a judgment criterion or taking a measure for change.

11. The project diagnosis DB system according to claim 1, wherein
the project diagnosis template includes at least a diagnosis sentence that prompts the user to answer whether a phase can be started after clarifying what is deliverables.

12. The project diagnosis DB system according to claim 1, wherein
the project diagnosis template includes at least a diagnosis sentence that prompts the user to answer whether misunderstanding between the parties concerned is reduced and a quality of an upstream process of the project is improved, by centrally managing requirements using a list.

13. The project diagnosis DB system according to claim 1, wherein
the project diagnosis template includes at least a diagnosis sentence that prompts the user to answer whether a preparation rule of a work schedule or a progress rate setting is clarified.

14. The project diagnosis DB system according to claim 1, wherein
the project diagnosis template includes at least a diagnosis sentence that prompts the user to the user answer whether consistency between a master schedule and a work schedule or consistency between the deliverables and the work schedule is confirmed.

15. The project diagnosis DB system according to claim 1, wherein
the project diagnosis template includes at least a diagnosis sentence that prompts the user to answer whether a person who reviews deliverables is clarified, a review task is registered in a work schedule, or a progress status of a review is visualized, in quality assurance.

16. The project diagnosis DB system according to claim 1, wherein
the project diagnosis template includes at least a diagnosis sentence that prompts the user to answer whether a participation schedule of undecided members or validity of skills and man-hours is confirmed.

17. The project diagnosis DB system according to claim 1, wherein
the project diagnosis template includes at least a diagnosis sentence that prompts the user to answer whether a meeting is set in consideration of reporting to a higher level, a content of the meeting is reviewed according to a situation, or a planned meeting is appropriately managed.

18. The project diagnosis DB system according to claim 1, wherein
the project diagnosis template includes at least a diagnosis sentence that prompts the user to whether an appropriate number of risks is extracted or a project-specific measure is considered, in risk management.
